(19) United States
(12) Patent Application Publication
(10) Pub. No.: US 2015/0339567 A1
(43) Pub. Date: Nov. 26, 2015

(54) RADIO IC-MOUNTED ARTICLE, MANUFACTURING METHOD THEREFOR, AND MANAGEMENT METHOD FOR RADIO IC-MOUNTED ARTICLE

(71) Applicant: TOPPAN FORMS CO., LTD., Tokyo (JP)

(72) Inventors: Nobuyuki Hirasaki, Tokyo (JP); Yuya Takahashi, Tokyo (JP); Hitoshi Kagaya, Tokyo (JP)

(21) Appl. No.: 14/647,746

(22) PCT Filed: Nov. 28, 2013
(86) PCT No.: PCT/JP2013/082101

§ 371 Date: May 27, 2015

(30) Foreign Application Priority Data
Nov. 29, 2012 (JP) 2012-261374
Nov. 21, 2013 (JP) 2013-241186

(51) Int. Cl. G06K 19/077; H01Q 1/22; G06K 7/10; H01Q 21/00

(52) U.S. Cl. CPC G06K 19/07794; H01Q 21/0087; H01Q 1/2225; G06K 7/10009

(57) ABSTRACT

A radio IC-mounted article communicates in a microwave band or an ultrahigh frequency band, and is provided with: a substrate on which an IC chip and an antenna electrically connected to the IC chip are mounted; a first booster antenna electromagnetically coupled to the antenna; a second booster antenna electromagnetically coupled to the first booster antenna; and an article on which the substrate, the first booster antenna, and the second booster antenna are mounted.

### TECHNICAL FIELD

The present invention is related to a radio IC-mounted article equipped with a radio IC, which is used as an information recording medium such as RFID (Radio Frequency Identification) and which is able to receive information from external by using radio wave as a medium and send information to outside; a manufacturing method and a management method of the radio IC-mounted article.

Priority is claimed on Japanese Patent Application 2012-261374 filed on Nov. 29, 2012, in Japan, and, on Japanese Patent Application 2013-241186 filed on Nov. 21, 2013 in Japan was, the contents of all of which are incorporated herein by reference.

### BACKGROUND ART

An IC tag includes a substrate and an inlet, wherein the inlet is composed of an antenna and an IC chip, which are connected to each other and are provided on a surface of the substrate. After receiving radio waves from an information writing/reading device (reader/writer), electromotive force is generated in the antenna by the resonance effect. The IC chip in the IC tag is started up by the electromotive force and the information in the IC chip is transferred to a signal which is transmitted from the IC tag antenna.

The IC tag is used for improving work efficiency and accuracy of logistics management in the management of goods in shops and warehouses or in the logistics, by recording information about each article to the IC chip which is attached to a cage cart and like used in the transportation of goods in stores and warehouse in which mass and variety of articles are handled or in the field of logistics.

As a structure of mounting an IC tag to a cage cart, it is known (for example, see Patent Document 1) that in the upper frame of a peripheral wall portion of cage cart, a recess is formed by chipping the upper part, wherein the recess is covered by mounting a non-metallic cover on the upper frame, and the IC tag is attached on the inner surface of the cover.

Patent Document 1: Japanese Patent Publication No. 2010-18410.

### SUMMARY OF THE INVENTION

However, in an IC tag using an IC chip and an antenna for microwave band or ultrahigh frequency band, the resonance setting is difficult because it is difficult to adjust the directivity and reading distance. Also, regarding the structure of mounting the IC tag to cage cart as disclosed in Patent Document 1, it is necessary to provide a recess in the cage cart. Therefore, an existing cage cart cannot be used. Also, since the cover is fitted with the IC tag on the inner surface, when the IC tag is attached to the cage cart, there is a risk of falling off from the cover.

The present invention has been made in view of the above circumstances. It is an object to provide a radio IC-mounted article having a radio IC in which even if an IC chip and an antenna for microwave band or ultrahigh frequency band is used, it is possible to adjust directivity and reading distance without fine resonant configuration and widen directivity; its manufacturing method; and a management method of the radio IC-mounted article.

A radio IC-mounted article of the present invention, which operates in microwave band or ultrahigh frequency band, includes a substrate on which an IC chip and an antenna electrically connected to the IC chip are mounted, a first booster antenna electromagnetically coupled to the antenna, a second booster antenna electromagnetically coupled to the first booster antenna, and an article on which the substrate, the first booster antenna and the second booster antenna are mounted.

In the radio IC-mounted article of the present invention, the first booster antenna is provided separately from the substrate.

In the radio IC-mounted article of the present invention, the first booster antenna includes a portion which is bent in a direction different from the surface direction of the substrate.

In the radio IC-mounted article of the present invention, the second booster antenna is a metal which the article is originally made of.

In the radio IC-mounted article of the present invention, the second booster antenna is a metal which is attached to the article.

In the radio IC-mounted article of the present invention, the article includes at least one columnar member, and the radio IC-mounted article includes a housing which is attached to the article, one portion of which is provided to face and intersect the columnar member; the substrate having the antenna and the IC chip, which is disposed on one surface of the housing; the first booster antenna which is disposed in a vicinity of the antenna in a non-bonding state with respect to the antenna; and a fixing member disposed with respect to the housing, for fixing the first booster antenna and the substrate to the housing so that at least a distal portion of the antenna is provided to face and intersect the columnar member,

A radio IC-mounted article of the present invention includes a substrate on which an IC chip which operates in microwave band or ultrahigh frequency band and an antenna electrically connected to the IC chip are mounted, a first booster antenna electromagnetically coupled to the antenna, a second booster antenna electromagnetically coupled to the first booster antenna, and an article having a metal, wherein the first booster antenna and the antenna are disposed so that the first booster antenna is electromagnetically coupled to the antenna, the first booster antenna and the metal of the article are disposed so that the first booster antenna is electromagnetically coupled to the metal of the article, and the antenna and the metal of the article are disposed so that the antenna is not electromagnetically coupled to the metal of the article.

A method manufacturing a radio IC-mounted article of the present invention which includes a substrate on which an IC chip which operates in microwave band or ultrahigh frequency band and an antenna electrically connected to the IC chip are mounted, a first booster antenna electromagnetically coupled to the antenna, a second booster antenna electromagnetically coupled to the first booster antenna, and an article having a metal, wherein the method includes steps of disposing the first booster antenna and the antenna so that the first booster antenna is electromagnetically coupled to the antenna, disposing the first booster antenna and the metal of the article so that the first booster antenna is electromagnetically coupled to the metal of the article, and disposing the antenna and the metal of the article so that the antenna is not electromagnetically coupled to the metal of the article.

A management method for a radio IC-mounted article of the present invention which includes a substrate on which an IC chip which operates in microwave band or ultrahigh frequency band and an antenna electrically connected to the IC chip are mounted, a first booster antenna electromagnetically coupled to the antenna, a second booster antenna electromagnetically coupled to the first booster antenna at least one columnar member, an article on which the substrate, the first booster antenna, the second booster antenna are mounted, and at least one columnar member, a housing which is attached to the article, one portion of which is provided to face and intersect the columnar member, a fixing member disposed to face the housing, wherein the management method includes steps of disposing the substrate having the IC chip and the antenna on one surface of the housing, disposing the first booster antenna in the vicinity of the antenna in a non-bonding state with respect to the antenna, disposing fixing member to face the housing, for fixing the first booster antenna and the substrate to the housing so that at least a distal portion of the antenna is provided to face and intersect the columnar member, carrying out reading/writing information to the IC chip in a non-contact manner by using an information reading/writing device.

Wireless communication in microwave band or ultrahigh frequency band has sensitive directivity and resonance sensitivity, however, by using the radio IC-mounted article of the invention, even if the second booster antenna communicating with the reading device may have any shapes, the second booster antenna can be electromagnetically coupled with an antenna which is electrically connected to the IC chip by changing the shape of the first booster antenna. That is, since the first booster antenna is arranged between the second booster antenna and an antenna connected with the IC chip, it is possible to adjust the directivity and reading distance without fine resonance setting. Also, according to the radio IC-mounted article of the present invention, it is possible to widen the directivity.

According to the manufacturing method of the radio IC-mounted article of the present invention, even if the IC chip and the antenna for microwave band or ultrahigh frequency band are used, it is possible to adjust the directivity and reading distance and to widen the directivity without fine resonance setting.

According to the management method of the radio IC-mounted article of the present invention, it is possible to accurately manage an article attached with the IC tag, and it is also possible to improve the work efficiency. In addition, according to the management method of radio IC-mounted article of the present invention, it is possible to reliably identify and separately manage each of the articles which have almost equal appearance and therefore it is difficult to distinguish at a glance when a large number of the articles are placed in a manner of overlapping each other.

### BRIEF DESCRIPTION OF THE DRAWINGS

FIG. 1 is a schematic perspective view showing a first embodiment of the IC tag in the invention.

FIG. 2 is a schematic perspective view showing part of a first embodiment of the IC tag in the invention.

FIG. 3 is a schematic perspective view showing part of a first embodiment of the IC tag in the present invention.

FIG. 4 is a schematic perspective view showing a first embodiment of a radio IC-mounted article of the present invention to show a method of using the first embodiment of the IC tag and to show a state of mounting the IC tag to a cage cart.

FIG. 5 is a schematic perspective view showing a first embodiment of a radio IC-mounted article of the present invention to show a method of using the first embodiment of the IC tag.

FIG. 6 is a schematic perspective view of a second embodiment of the IC tag in the present invention.

FIG. 7 is a schematic perspective view showing part of a second embodiment of the IC tag in the present invention.

FIG. 8 is a schematic perspective view showing part of a second embodiment of the IC tag in present invention.

FIG. 9 is a schematic perspective view showing how to use a second embodiment of the IC tag in the present invention.

FIG. 10 is a schematic planar view showing an example of arrangement of the inlet and the antenna member.

FIG. 11 is a schematic planar view showing another example of arrangement of the inlet and the antenna member.

FIG. 12 is a schematic perspective view showing a third embodiment of the IC tag in the present invention.

FIG. 13 is a schematic perspective view showing a fourth embodiment of the IC tag in the present invention.

FIG. 14 is a schematic perspective view of a fifth embodiment of the IC tag in the present invention.

FIG. 15 is a schematic cross-sectional view showing an example of the fitting structure of the housing and the fixing member.

FIG. 16 is a schematic cross-sectional view showing another example of the fitting structure of the housing and the fixing member.

FIG. 17 is a schematic cross-sectional view showing another example of the fitting structure of the housing and the fixing member.

FIG. 18 is a schematic cross-sectional view showing another example of the fitting structure of the housing and the fixing member.

### DETAIL DESCRIPTION OF THE INVENTION

A radio IC-mounted article of the present invention, its manufacturing method, and an embodiment of the management method of radio IC-mounted article are explained.

The embodiment will be specifically described for better understanding of the spirit of the invention, and unless otherwise specified, the embodiment does not limit the present invention.

### (1) First Embodiment

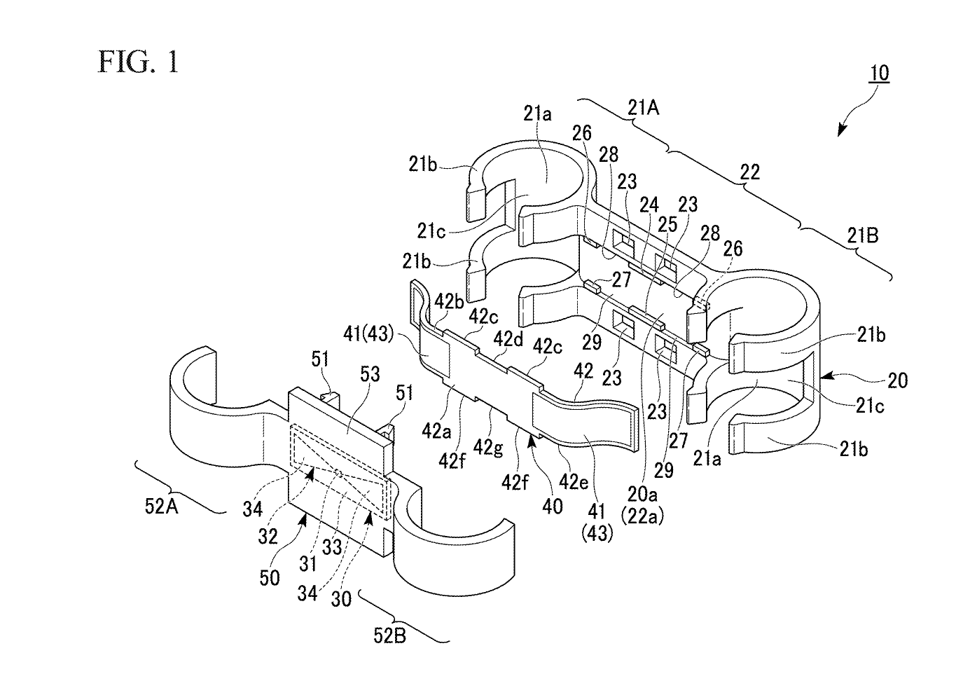

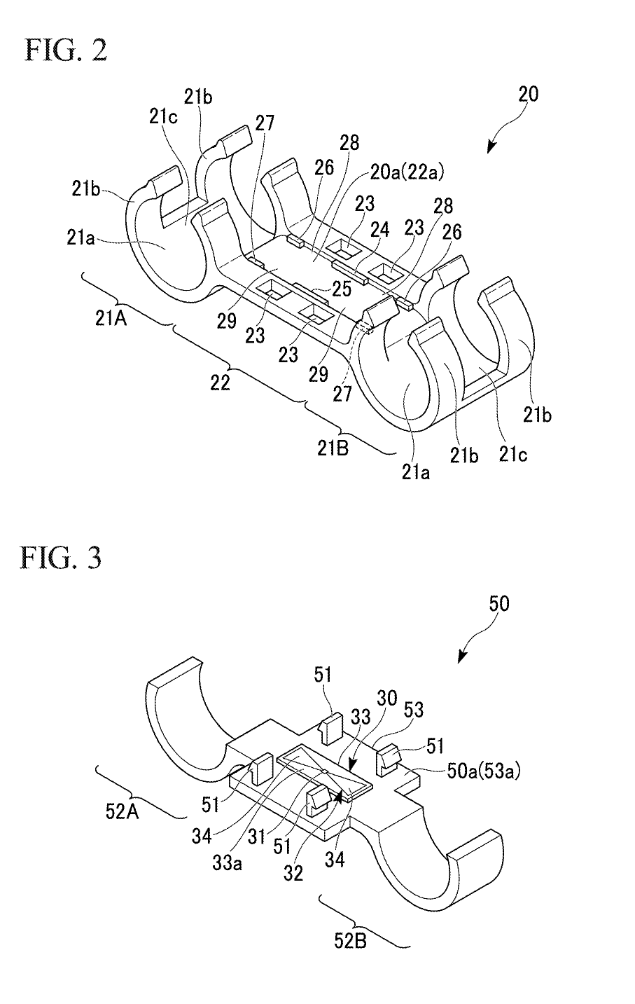

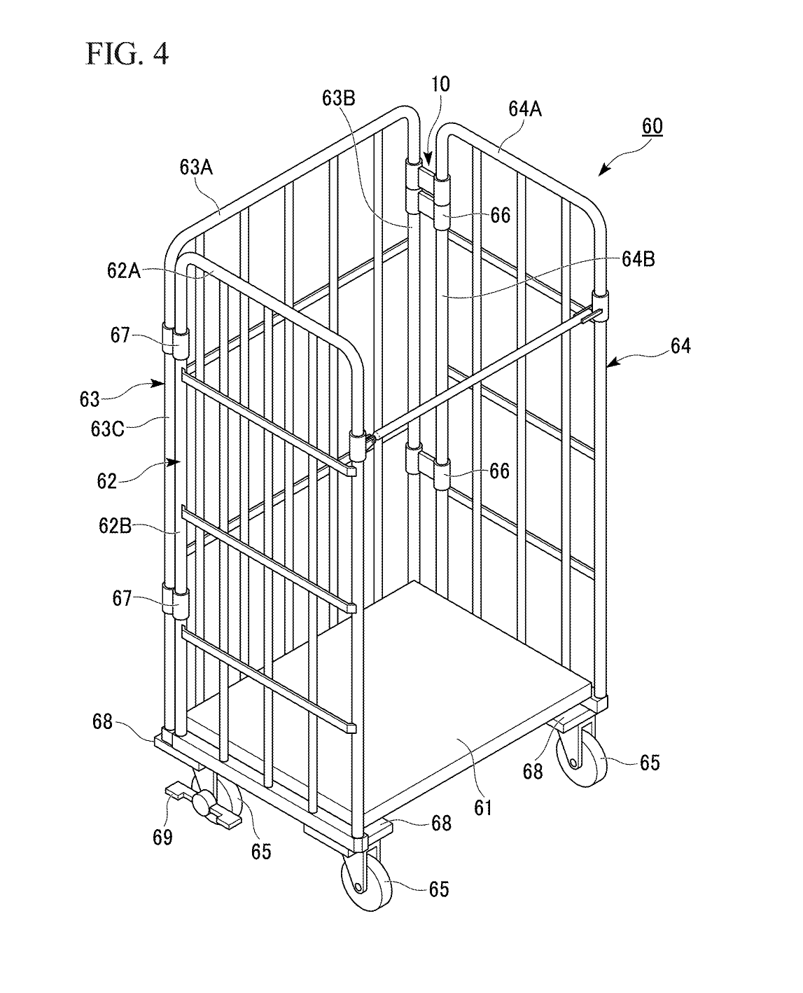

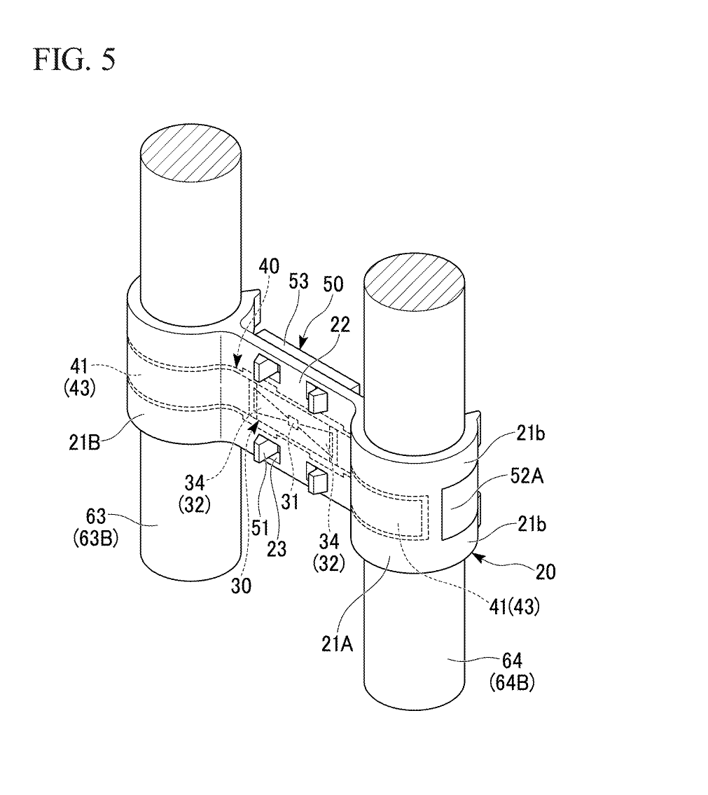

FIG. 1 is a schematic perspective view showing a first embodiment of the IC tag in the present invention. FIG. 2 is a schematic perspective view showing part of the first embodiment of the IC tag in the present invention. FIG. 3 is a schematic perspective view showing part of the first embodiment of the IC tag in the present invention. FIG. 4 is a schematic perspective view showing the first embodiment of a radio IC-mounted article of the present invention to show a method of using the first embodiment of the IC tag and to show a state of mounting the IC tag to a cage cart. FIG. 5 is a schematic perspective view showing the first embodiment of a radio IC-mounted article of the present invention to show a method of using the first embodiment of the IC tag.

An IC tag 10 of the present embodiment includes a housing 20, an inlet 30, an antenna member 40 and a fixing member 50, wherein the inlet 30 is disposed on a surface 20a of the housing 20 and has an IC chip 31 and a first antenna 32; the first antenna 32 is the antenna in the present invention and is electrically connected to the IC chip 31; the antenna member 40 has a second antenna 41 which is the first booster antenna in the present invention and is arranged in the vicinity of the first antenna 32 in a non-bonding state with respect to the first antenna 32; and the fixing member 50 fixes the inlet 30 and the antenna member 40 to the housing 20.

The IC tag 10 is used, for example, by attaching it to the cage cart 60, as shown in FIG. 4. In the present embodiment, the IC tag 10 is described when it is attached to the cage cart 60. The radio IC-mounted article of the present embodiment includes, for example, the IC tag 10, and the cage cart 60.

The inlet 30 includes a substrate 33, an IC chip 31, and a first antenna 32, wherein the substrate 33 is a film-like or sheet-like form and has a rectangular shape in planar view. In addition, the IC chip 31 and the first antenna 32 are provided on a surface 33a of the substrate 33. The IC chip 31 and the first antenna 32 are electrically connected to each other. In addition, the first antenna 32 is a dipole antenna and includes a pair of radiating elements 34, 34 which are opposed to each other and each of which has a feeding point (portion for connecting with the IC chip 31) on the opposite side.

The antenna member 40 includes a substrate 42 and a second antenna 41, wherein the substrate 42 is a film-like or sheet-like form and has a substantially rectangular shape in planar view; and the second antenna 41 is composed of a pair of planar (rectangular) radiating elements 43, 43, which are provided at an interval on a surface 42a of the substrate 42 to oppose to each other, and face the first antenna 32 (radiating elements 34, 34) of inlet 30.

The second antenna 41 has a length corresponding to half wavelength of radio frequency of ultrahigh frequency band (UHF) or microwave band (300 MHz to 30 GHz) which is available in a non-contact IC module, such as a non-contact IC card. That is, the radiating elements 43, 43 in the longitudinal direction have a length corresponding to ¼-wavelength. In addition, the radiating elements 43, 43 provided on the surface 42a of the substrate 42 have a length that extend to the outer fitting portions 21A, 21B of the housing 20 when the antenna member 40 is placed on the surface 22a of the connecting portion 22 of the housing 20, which will be described later.

The means that the second antenna 41 is disposed in the non-bonding state in the vicinity of the first antenna 32 with respect to the first antenna 32 is a state that the first antenna 32 and the second antenna 41 are not bonded (fixed) directly; however, these two antennas are electrically connected by electrostatic coupling or electromagnetic coupling.

Also, the first antenna 32 of the inlet 30 is not an antenna for communicating with the information writing/reading device directly. The first antenna 32 of the inlet 30 is an antenna for performing the electrical connection between the second antenna 41 of the antenna member 40 by electrostatic coupling or electromagnetic coupling. In other words, the second antenna 41 of the antenna member 40 communicates with the information writing/reading device directly.

In a portion of substrate 42 of the antenna member 40, which is placed on the surface 20a (the surface 22a of the connecting portion 22) on the housing 20, wherein the portion is a portion of the substrate 42 on which the radiating elements 43, 43 are not provided in this embodiment and is a central portion of the substrate 42, a pair of rectangular ridges (fitting portions) 42c, 42c in planar view are provided in an interval, wherein the ridges 42c, 42c protrude outward to the direction perpendicular to the longitudinal direction of the antenna member 40 from one side face 42b as a base which is along the longitudinal direction of the substrate 42. As a result, rectangular fitting recesses (fitting portions) 42d, 42d in planar view which are recessed inside in the direction perpendicular to longitudinal the direction of the antenna member 40 (longitudinal direction of the connecting portion 22 of the housing 20) are formed, between the pair of ridges (fitting portions) 42c, 42c, in other words, in the central portion in the longitudinal direction of the substrate 42. The pair of ridges (fitting portions) 42c, 42c are provided at symmetrical positions with a center line perpendicular to the longitudinal direction of the connecting portion 22.

Similarly, in the portion of the substrate 42 of the antenna member 40, which is placed on the surface 20a (the surface 22a of the connecting portion 22) of the housing 20, wherein the portion is a portion of the substrate 42 on which the radiating elements 43, 43 is not provided in this embodiment and is a central portion of the substrate 42, a pair of rectangular ridges (fitting portions) 42f, 42f in planar view are provided in an interval, wherein the ridges 42f, 42f protrude outward to the direction perpendicular to the longitudinal direction of the antenna member 40 from one surface 42e as a base which is along the longitudinal direction of the substrate 42. As a result, rectangular fitting recesses (fitting portions) 42g, 42g in planar view which are recessed inside in the direction perpendicular to longitudinal the direction of the antenna member 40 (longitudinal direction of the connecting portion 22 of the housing 20) is formed between the pair of ridges (fitting portions) 42f, 42f, and in other words in the central portion in the longitudinal direction of the substrate 42. The pair of ridges (fitting portions) 42f, 42f are provided at symmetrical positions with a center line perpendicular to the longitudinal direction of the connecting portion 22.

The fitting recesses (fitting portions) 42d, 42g are provided at symmetrical positions with a center line parallel to the longitudinal direction of the connecting portion 22.

As a cage cart mounted with the IC tag 10, for example, a cage cart 60 is shown in FIG. 4.

The cage cart 60 has a mounting table 61, peripheral wall portions 62, 63, 64, and multiple wheels 65, wherein the mounting table 61 having a rectangular shape in planar view is placed for supporting the article; the peripheral wall portions 62, 63, 64 which stand on the three sides as ends among the four sides of the mounting table 61 have an elongated top frames 62A, 63A, 64A along the horizontal direction in the upper part and are formed in a lattice shape as a whole; the wheels 65 is lower than the mounting table 61 and are placed at the four corners of the mounting table 61.

It is possible to push the cage cart 60 by hands by using the wheels 65 provided at the four corners of the mounting table 61.

The rear end of the mounting table 61 is rotatably supported around a horizontal axis by the lower end of the peripheral wall portion 63 provided on the rear end side of the mounting table 61 through a hinge member (not shown), wherein the rear end is a side that faces the front end of the mounting table 61, when the front end is a side in which no one of peripheral wall portions 62, 63, 64 is provided. As a result, the mounting table 61 is rotatably supported in the manner of folding upward freely with respect to the peripheral wall portion 63.

Also, one side edge portion 63B of the peripheral wall portion 63 (right side edge portion in FIG. 4) is connected to an adjacent side edge portion 64B of the peripheral wall portion 64 (right peripheral wall portion 64) through a hinge member 66. In addition, another side edge portion 63C of the peripheral wall portion 63 (left side edge portion in FIG. 4) is connected to an adjacent side edge portion 62B of the peripheral wall portion 62 (left peripheral wall portion 62) through a hinge member 67.

In addition, the side edge portion 64B of the peripheral wall portion 64 is rotatably supported by the right side edge portion of the peripheral wall portion 63 (one of the side edge portion 63B) around the vertical axis through a hinge member 66. Thus, the peripheral wall portion 64 is foldable so as to sandwich the mounting table 61 folded upward between the peripheral wall portion 64 and the peripheral wall portion 63.

In other words, the mounting table 61 is configured to a loading state in which it is placed along the horizontal direction by swinging operation around the horizontal axis, or a storing state in which the mounting table 61 is folded upward along the vertical direction to overlap the peripheral wall portion 63. In addition, the peripheral wall portion 64 is configured to a using state in which it is placed in a state along the longitudinal direction by the swinging operation around the vertical axis, or to a folding state in which it is placed along the width direction and folded inward to overlap the side peripheral wall portion 63 and the mounting table 61.

The cage cart 60 may be folded to be an L-shape in a planar view by changing the state from loading state to storing state by folding mounting table 61 upward, and then, change the using state to folding state by folding the peripheral wall portion 64 inward. It is possible to overlap multiple cage carts 60 so as to store them in a space-saving by overlapping one folded cage cart 60 in an L-shape with another folded cage cart 60 in an L-shape on the inner side and outer side.

A stopper 69 of the wheels 65, as lock means, is attached to the support 68 supporting the wheels body in a manner of freely-idling. The stopper 69 is mounted rotatably around a rotation axis of the wheels 65 at an unlocked position at which the stopper 69 is in inclined state to allow the rolling of wheels 65 or at a locked position at which the stopper 69 is in a horizontal state to prohibit the rolling of the wheels 65. In other words, the stopper 69 is mounted for freely switching operation in manual from an open state of allowing rolling of wheels 65 to a disabled state of prohibiting rolling of the wheels 65.

The peripheral wall portions 62, 63, 64 may be made of a metal, a plastic or a wooden. The top frame 62A, 63A, 64A and the side edge portions 62B, 63B, 63C, 64B which form an outer frame of the peripheral wall portions 62, 63, 64 (frame) are cylindrical (columnar member).

When the IC tag 10, as shown in FIGS. 4 and 5, is attached to the cage cart 60, the housing 20 is arranged to bridge the two side edge portions 63B, 64B of two adjacent peripheral wall portions 63, 64 connected through a hinge member 66.

The housing 20 has a pair of outer fitting portions 21A, 21B and a tabular connecting portion 22, wherein the pair of outer fitting portions 21A, 21B are provided away from each other and fitted from the each outside to the two side edge portions 63B, 64B; and the connecting portion 22 is interposed between the pair of outer fitting portions 21A, 21B, so as to be perpendicular to the outer fitting portions 21A, 21B. In other words, the housing 20 has a substantially dumbbell shape which is formed by connecting the pair of outer fitting portions 21A, 21B through the connecting portion 22.

The outer fitting portions 21A, 21B include a pair of claw portions 21b, 21b and the connecting portion 21c, wherein the pair of claw portions 21b, 21b are provided apart from each other in the width direction of the housing 20; and the connecting portion 21c connecting the claw portions 21b, 21b are interposed between the pair of claw portions 21b, 21b. The width direction of the housing 20 is a direction along the longitudinal direction of the side edge portions 63B, 64B of the peripheral wall portion 63,64 of the cage cart 60 wherein the side edge portions 63B, 64B are fitted from the outside by the outer fitting portions 21A 21B of the housing 20, respectively. On the other hand, the longitudinal direction of the housing 20 is a direction perpendicular to the longitudinal direction of the side edge portions 63B, 64B of the peripheral wall portion 63,64 of the cage cart 60 wherein the side edge portions 63B, 64B are fitted from the outside by the outer fitting portions 21A 21B of the housing 20, respectively. In addition, surfaces (hereinafter, “inner face”) 21a, 21a of the outer fitting portions 21A, 21B wherein the surfaces face the side edge portions 63B, 64B, have shapes corresponding to external dimensions of the side edge portions 63B, 64B, which have an arc shape.

In addition, the inner surfaces 21a, 21a of the outer fitting portions 21A, 21B are a surface of the claw portion 21b wherein the surface faces the outer peripheral surface of the side edge portions 63B, 64B when the outer fitting portions 21A, 21B are fitted to the side edge portions 63B, 64B from the outside, and the surface of the connecting portion 21c wherein the surface faces outer peripheral surface of the side edge portions 64B, 63B. The claw portions 21b, 21b are provided by along the external dimension (outer peripheral surface) of the side edge portions 63B, 64B, and have a longer length than that of the portion 21c and have a length in which ½ to ¾ of the external circumference of the side edge portions 64B, 63B is covered by the claw portions 21b, 21b.

As a result, when the outer fitting portions 21A, 21B are fitted to the side edge portions 63B, 64B from the outside, with respect to the outer peripheral surface of the side edge portions 63B, 64B, the bonding of the inner surfaces 21a, 21a of the outer fitting portions 21A, 21B increases. The IC tag 10 is firmly clamped to the side edge portions 63B, 64B.

On the surface 22a of the connecting portion 22 of the housing 20 (hereinafter, “one surface”), wherein the surface 22a faces the side edge portions 63B,64B, at both ends in the width direction, four rectangular fitting holes 23 in planar view are provided, wherein the fitting holes 23 are fitted to four fitting projections 51 standing on the surface 50a of fixing member 50 (hereinafter, “one surface”) which faces the housing 20, and the fitting holes 23 penetrate through the connecting portion 22 in the thickness direction. Also, the four fitting holes 23 are provided at symmetrical positions with two center lines one of which is the line parallel to longitudinal direction of the connecting portion 22, and another of which is the line perpendicular to the longitudinal direction of the connecting portion 22.

Also, on one surface 22a of the connecting portion 22 of the housing 20, in the central portion of the connecting portion 22, rectangular fitting projections in planar view (fitting portions) 24 are provided. The fitting projection 24 extends in the longitudinal direction of the connecting portion 22, fitted into the fitting recess 42d which is formed between the ridges 42c, 42c provided in the substrate 42 of the antenna member 40.

Similarly, on the surface 22a of the connecting portion 22 of the housing 20, in the central portion of the connecting portion 22, rectangular fitting projection (fitting portion) 25 in planar view is provided. The fitting projection 25 extends in the longitudinal direction of the connecting portion 22, fitted into the fitting recess 42g which is formed between the ridges 42f, 42f provided in the substrate 42 of the antenna member 40. In other words, the fitting projections 24 and 25 have almost the same shape as the fitting recess 42d and 42g, and are provided at a symmetrical position with a center line parallel to the longitudinal direction of the connecting portion 22.

Furthermore, on one surface 22a of the connecting portion 22 of the housing 20, at both ends in the longitudinal direction, four rectangular fitting projections in planar view (fitting portions) 26, 26, 27, 27 are protruded at a predetermined interval, wherein the fitting projections (fitting portions) 26, 26, 27, 27 are fitted to the projection portions 42c, 42c, 42f, 42f of the antenna member 40. In other words, the fitting projections 26 and 26 as a pair are fitted from the outside to one side face 42b of substrate 42 of the antenna member 40, and the fitting projections 27, 27 as a pair are fitted from the outside to the other side 42e of substrate 42 of the antenna member 40.

A recess 28, which is formed between the fitting projection 26 and the fitting projection 24, has almost the same shape as the external shape of the ridge portion 42c of the substrate 42 of the antenna member 40. Similarly, a recess 29 which is formed between the fitting projection 27 and the fitting projection 25 has almost the same shape as the external shape of the ridge 42f of the substrate 42 of the antenna member 40. Then, a pair of fitting projections 26, 26 and a pair of fitting projections 27, 27 are provided at symmetrical positions with a center line perpendicular to a longitudinal direction of the connecting portion 22.

The fixing member 50 schematically includes a pair of outer fitting portions 52A, 52B, and a planar connecting portion 53, four substantially rectangular columnar fitting projections 51, wherein the outer fitting portions 52A, 52B are fitted from the outside to the above-mentioned side edge portions 63B,64B, the connecting portion 53 is interposed between the pair of outer fitting portions 52A, 52B, and is perpendicular to the outer fitting portions 52A, 52B which are connected by the connecting portion 53; the columnar fitting projections 51 stand at the four corners of a surface 53a of the connecting portion 53 wherein the surface 53a faces the housing 20 (hereinafter, “one surface”). That, fixing member 50 has a substantially dumbbell shape in which a pair of outer fitting portions 52A, 52B are connected via a connecting portion 53. The magnitude (area) of the connecting portion 53 is approximately equal to the portion 22 of the housing 20. Furthermore, the four fitting projections 51 are provided at symmetrical positions with one center line perpendicular to the longitudinal direction of the connecting portion 53, or with another center line parallel to the longitudinal direction of the connecting portion 53.

In addition, the external shape of outer fitting portions 52A, 52B of the fixing member 50 is equal to the gap between claw portions 21b, 21b which are provided in the outer fitting portions 21A, 21B of the housing 20. Therefore, when the fixing member 50 is fixed to the housing 20, the fitting projections 51 of the fixing member 50 are fitted into the fitting holes 23 of the housing 20. At the same time, the outer fitting portions 52A, 52B of fixing member 50 are fitted between the claw portions 21b, 21b of the outer fitting portions 21A, 21B of the housing 20. Therefore, the outer fitting portions 21A, 21B of the housing 20 and the outer fitting portions 52A, 52B of fixing member 50 are fitted to above-mentioned side edge portions 63B, 64B from the outside. And as a result, the IC tag 10 is fixed to the cage cart 60.

In addition, the housing 20 is made from non-conductive member, or made of a composite material containing non-conductive member and metal. Among the connecting portion 22, at least a portion (hereinafter, “portion α”) in which the inlet 30 is placed may be made of a non-conductive member. Therefore, a portion other than the portion α in connecting portion 22 of the housing 20 may be made of any one of a non-conductive member, a metal and the composite material containing a non-conductive member and a metal. For example, the connecting portion 22 of the housing 20 may be made from a non-conductive member, and the outer fitting portions 21A, 21B may be made of a metal.

Similarly, the fixing member 50 may be made of a non-conductive member or a composite material containing the non-conductive member and the metal. Among the connecting portion 53, at least the portion (hereinafter, “portion β”) in which the inlet 30 is placed may be made of a non-conductive member. Therefore, a portion other than the portion β in the connecting portion 53 of the fixing member 50 may be made of any one of a non-conductive member, a metal, and a composite material containing a non-conductive member and a metal. For example, the connecting portion 53 of the fixing member 50 may be made of a non-conductive member, and the outer fitting portions 52A, 52B may be made of a metal.

A non-conductive member constituting the housing 20 or the fixing member 50 is not particularly limited. For example, a non-conductive member which is made of a polyester resin such as polyethylene naphthalate (PEN), polyethylene terephthalate (PET), polybutylene terephthalate (PBT); polyolefin resins such as polypropylene (PP), polyethylene (PE); polyfluorinated ethylene resin such as polyvinyl fluoride, polyvinylidene fluoride, polyethylene tetrafluoride; polyamide resins such as nylon 6, nylon 6,6; vinyl polymers such as polyvinyl chloride (PVC), ethylene-vinyl acetate copolymer, polyvinyl alcohol, vinylon; acrylic resins such as polymethyl methacrylate, ethyl polymethacrylate, ethyl polyacrylate, polyacrylic acid butyl; polystyrene; polycarbonate (PC); polyarylates; polyimides; or glass-plastic such as an epoxy resin may be used.

As the substrate 33 of the inlet 30 and the substrate 42 of the antenna member 40, a substrate which is made of a polyester resin such as polyethylene terephthalate (PET), glycol-modified polyethylene terephthalate (PET-G), polybutylene terephthalate (PST), polyethylene naphthalate (PEN); polyolefin resins such as polyethylene (PE), polypropylene (PP); polyfluorinated ethylene resin such as polyvinyl fluoride, polyvinylidene fluoride, polyethylene tetrafluoride; polyamide resins such as nylon 6, nylon 6,6; vinyl polymers such as polyvinyl chloride (PVC), ethylene-vinyl acetate copolymer, polyvinyl alcohol, vinylon; acrylic resins such as polymethyl methacrylate, ethyl polymethacrylate, ethyl polyacrylate, polyacrylic acid butyl; Polystyrene; polycarbonate (PC); polyarylates; polyimides; or paper such as high-quality paper, tissue paper, glassine paper, parchment paper may be used.

As the IC chip 31 of the inlet 30, it is not particularly limited. Any IC chip which may be applied to RFID media, such as contactless IC tag, a non-contact type IC labels, non-contact type IC card or like may be used so long as the IC chip may write or read information through the first antenna 32 in a non-contact state.

The first antenna 32 of inlet 30 is formed by printing a predetermined pattern using a polymer type conductive ink by using a printing method such as screen printing or ink-jet printing, or by etching a conductive foil, or by metal-plating on one surface 33a of substrate 33.

The second antenna 41 of the antenna member 40 is formed by printing a predetermined pattern using a polymer type conductive ink by using a printing method such as screen printing or ink-jet printing, or by etching a conductive foil, or by metal-plating on one surface 42a of substrate 42.

As the polymer-type conductive ink, for example, an ink obtained by blending an ink conductive fine particles such as silver powder, gold powder, platinum powder, aluminum powder, palladium powder, rhodium powder, carbon powder (carbon black, carbon nanotubes) or like with a resin composition may be used.

When a thermosetting resin is used as the resin composition, the polymer type conductive ink is a thermosetting-typed ink which may be used to form the first antenna 32 or the second antenna 41 by forming a coating film at 200° C. or less, for example, on the order of 100-150° C. An electricity flow paths of the coating film constituting the first antenna 32 or the second antenna 41 is formed by contacting the conductive particles with each other. A resistance of the coating is 10⁻⁵ Ω·cm order.

Also, as the polymer type conductive ink of the invention, in addition to a heat curable type, any other type of a known ink such as a light-curing type, penetration-drying type, or solvent-volatile type may be used.

Since a photocurable polymer type conductive ink includes a resin composition including a photocurable resin has a short curing time, it is possible to improve the manufacturing efficiency. As the photocurable polymer type conductive ink, for example, an ink of solvent volatilization type or cross-linking/thermoplastic combination type (however, thermoplastic type is not less than 50 mass %) which contains a thermoplastic resin only or a resin composition of a thermoplastic resin and crosslinking resin (in particular, a cross-linked resin with a polyester and an isocyanate), not less than 60 wt % of a conductive fine particles, and not less than 10 wt % a polyester resin; or an ink of a cross-linked or cross-linking/thermoplastic combination type which containing a thermoplastic resin alone, or a resin composition of a thermoplastic resin and crosslinking resin (in particular, a cross-linked resin with a polyester and an isocyanate), and not less than 10 wt % of polyester resin may be used; and cross-linking type or cross-linking/thermoplastic combination type is preferably used.

In addition, as a conductive foil that forms the first antenna 32 or the second antenna 41, copper foil, silver foil, gold leaf, platinum foil, aluminum foil, or like may be used.

In addition, as metal plating that forms the first antenna 32 or second antenna 41, copper plating, silver plating, gold-plating, platinum-plating or like may be used.

According to this IC tag 10, the fitting projections 24, 26, 26 provided on the connecting portion 22 of the housing 20 are fitted from the outside to one side face 42b of substrate 42 of the antenna member 40; and the fitting projections 25, 27, 27 provided on the connecting portion 22 of the housing 20 are fitted from the outside to the other side 42e of substrate 42 of the antenna member 40; and further in the state that the inlet 30 is provided on a surface 20a (in this case, above a surface 53a of connecting portion 53 of fixing member 50) of the housing 20, the housing 20 and the fixing member 50 are fitted to the side edge portions 63B 64B of a cage cart 60 from the outside. By that, the inlet 30 and the antenna member 40 are fixed to the surface 22a of the connecting portion 22 of the housing 20, therefore, during a work of installation of the IC tag 10 to the cage cart 60, the inlet 30 and the antenna member 40 never fall off from the housing 20. Therefore, it is possible to attach the IC tag 10 to the cage cart 60 easily. In addition, by using the outer fitting portions 21A, 21B of the housing 20 and the outer fitting portions 52A, 52B of fixing member 50, the IC tag 10 is fixed to the above-mentioned side edge portions 63B, 64B, therefore, it is possible to more firmly fix the IC tag 10 to the cage cart 60.

Also, since the inlet 30 and the antenna member 40 may be separated, when one of these is broken, it is possible to be used in the same manner by replacing only the broken member. Therefore, it is possible to reduce the cost.

In the present embodiment, the inlet 30 exemplify includes a substrate 33, a IC chip 31, a first antenna 32, however, the present invention is not limited thereto. In the present invention, an inlet may be composed of only a first antenna and an IC chip which is provided on a surface of the fixing member wherein the surface faces the housing.

Further, in the present embodiment, it was exemplified that the rectangular projections 42c, 42c, 42f, 42f in planar view are provided in a portion of substrate 42 of the antenna member 40, wherein in the portion, the surface 22a of the connecting portion 22 of the housing 20 is provided. However, the present invention is not limited thereto. In the present invention, the shape of ridges provided to substrate of the antenna member (fitting portion) may be a semicircular shape, rectangular shape, polygonal shape (more pentagon) or like, in planar view. Then, the shapes of the fitting projections provided on connecting portion of the housing which depend on the shapes of said ridges (fitting portions), may be semi-cylindrical, square pillar, polygonal shape (five or more of the columnar) or like.

Further, in the present embodiment, in the connecting portion 22 of the housing 20, four rectangular holes 23 in planar view are exemplify provided. However, the present invention is not limited thereto. In the present invention, the shapes of the fitting holes provided in the connecting portion of the housing may be circular, semicircular shape, elliptical shape, triangular shape, square shape, polygonal shape (pentagonal or more) or like, in planar view. In addition, the number of fitting holes provided in the connecting portion of the housing is not particularly limited so long as it may be stably secure the fixing member to the housing. Also, the shape of the fitting projections provided in the connecting portion of the fixing member depending on the shape of the fitting hole may be cylindrical, semi-cylindrical, oval columnar, triangular, polygonal shape (five or more of the columnar) or like.

In addition, in the present embodiment, for example, the fitting projections 24, 26, 26 provided in the connecting portion 22 of the housing 20 are fitted to one side face 42b of substrate 42 of the antenna member 40 from the outside, and the other fitting projections 25, 27, 27 provided on the connecting portion 22 of the housing 20 are fitted from the outside to the other side 42e of substrate 42 of the antenna member 40. The present invention is not limited thereto. In the present invention, the fitting projections provided on the connecting portion of the housing may be fitted from the outside to one side face of the substrate of the inlet, and the other fitting projections provided on the housing of the connecting portion are fitted from the outside to the other side of the substrate of the inlet.

In the present embodiment, for example, the housing 20 is provided between the two side edges portions 63B, 64B provided in parallel, so as to bridge these. The invention is not limited thereto. In the present invention, two adjacent columnar members to which the IC tag is attached may be provided not in parallel, and for example, may intersect each other. Thus, even if two of the columnar members adjacent intersect, the housing is provided so as to bridge the two columnar members. Also, in the present invention, the article to which IC tag is attached includes at least one columnar member. In this case, the housing of IC tag is arranged so that part of the housing intersects and faces the columnar member, and is attached to an article. In addition, the fixing member of IC tag is provided to face the housing so that at least part of the tip of the antenna intersects and faces the columnar member, in order to fix the inlet and the second antenna to the housing.

Also, if columnar member constituting the cage cart is made of metal, it is preferably that some or all of the distal end portions of the radiating element of the second antenna is provided to cross the columnar member. In this case, with respect to the columnar member, an intersection angle of the part or all of the distal end portions of the radiating element is preferably 90° and in a practical view point, the angle is more preferably from 45° to 90 °.

Thus, electric current flows between the radiating element of the second antenna and the metal of the columnar member by electromagnetic induction or electrostatic induction, and the columnar member is part of the second antenna and functions as an extension portion of the second antenna. Therefore, it is not possible to communicate from the longitudinal direction of the inlet only by the second antenna. However, through the columnar member constituting an extension of the second antenna, and it becomes communicable from the longitudinal direction of the inlet. That is, the metal of the columnar member becomes the second booster antenna of the present invention. Through the metal of the columnar member, it is possible to widen directivity of the second antenna (weak directivity).

Also, when the columnar member is made of metal, and the outer fitting portion of the housing are fitted to the two adjacent columnar members, it is preferable that the columnar members protrude from the housing in a view from one surface or another side (facing side) of the housing. The means that the columnar members protrude from the housing is that when some or all of the distal end portions of the radiating element of the second antenna cross the columnar members, the length of the columnar members is greater than the width of the outer fitting portion of the housing (the length in a direction perpendicular to the longitudinal direction of the housing). In this way, through the metal columnar member, it is possible to transmit and receive radio waves more efficiently from the longitudinal direction of the inlet. That is, via the metal columnar member, the second antenna may have wider directivity (weaker directivity).

In addition, it is preferable that the protruding direction of the columnar member with respect to the housing are both ends in the width direction of the outer fitting portion of the housing. In this way, it is possible to widen the directivity of the second antenna (weak directivity) through the metal columnar member when the protruding direction of the columnar member with respect to the housing is two sides, more than when the direction is only one side in the width direction of the outer fitting portion of the housing.

The protruding amount to the housing of the columnar member is not particularly limited, and if necessary, it may be appropriately adjusted.

In the present embodiment, for example, the two of the columnar members (side edge portions 63B, 64B) are separately provided, and when the metal members does not exist between these columnar members, the IC tag 10 is disposed to bridge the columnar members (side edge portions 63B, 64B). There is no metal member in the vicinity of the first antenna 32 (the antenna of the present invention). However, the present invention is not limited thereto. In the present invention, a metal member may be provided between the two columnar members. In that case, the antenna and the metal member may be provided not to close each other, and be separated so long as the metal member does not affect the antenna.

That is, when the metal member is present between the two columnar members (second booster antenna in the present invention), the second antenna 41 (first booster antenna in the present invention) and the first antenna 32 (antenna, in the present invention) are provided so that the second antenna 41 and the first antenna 32 are coupled electromagnetically. In addition, the second antenna 41 is disposed with respect to the side edge portions 63B, 64B (columnar members) of the cage cart 60 so that the second antenna 41 and the side edge portions 63B, 64B (columnar member, metal with an article in the present invention) of the cage cart 60 are coupled electromagnetically. In addition, the first antenna 32 are disposed with respect to the side edge portions 63B, 64B of the cage cart 60 (columnar member) so that the first antenna 32 and the side edge portions 63B, 64B of cage cart 60 are not coupled electromagnetically. In this way, since the first antenna 32, the second antenna 41, the side edge portions 63B, 64B of the cage cart 60 (columnar member) are provided as described above, even if the IC chip and an antenna for microwave band or ultrahigh frequency band is used, it is possible to adjust directivity and reading distance without fine resonance setting, and it is possible to widen directivity.

Also, when there is a metal member between the two columnar members, the distance A between the metal members and the antenna may be greater than the distance B between the first booster antenna and the second booster antenna (two columnar members).

Specifically, it is preferable that the distance A between the metal member and the antenna is at least about 3 cm, and the distance B between the first booster antenna and the second booster antenna is about from 0.1 mm to 2 mm.

In addition, in order to cause electromagnetic induction or electrostatic induction between the tip of the radiating element of the second antenna and the columnar members, both of them may be closely contacted or not, so long as they may face each other. Thus, a coating may be provided to cover the second antenna on one surface of the antenna member.

The coating is provided for protecting the second antenna, bonding the outer fitting portions and the columnar members, and improving holding force of the outer fitting portions to the columnar members.

The thickness of the coating, depending on its purpose, is appropriately adjusted.

A material of the coating is not particularly limited, and for bonding of outer fitting portion and the columnar member or for improvement of the holding force of the outer fitting portion to the columnar member, synthetic rubber (elastic rubber) is preferably used, wherein the rubber may include acrylic rubber, acrylonitrile butadiene rubber, isoprene rubber, urethane rubber, ethylene-propylene rubber, epichlorohydrin rubber, chloroprene rubber, silicone rubber, styrene-butadiene rubber, butadiene rubber, fluorine rubber, butyl rubber, or like.

In addition, in the present embodiment, for example, the IC tag 10 is attached to the cage cart 60, however, the invention is not limited thereto. The IC tag in the present invention may be applied to all articles which have at least two adjacent columnar members. Also, as an article having a structure with at least two adjacent columnar member, for example, a furniture such as a chair, a table, a desk, a chest or like; a dolly or like.

Also, according to the radio mounted article of this embodiment, even if directivity and resonance sensitivity of the wireless communication microwave band or ultrahigh frequency band is sensitive, it is possible that the second booster antenna which communicates with the information reading/writing unit (reader/writer) and has any shapes may be electromagnetically coupled with the antenna electrically connected the IC chip by changing the shape of the first booster antenna. That is, it is possible to adjust the directivity and the reading distance without fine resonant settings by providing the first booster antenna between the antenna connected to the IC chip and the second booster antenna. Since the information reading/writing device (reader/writer) has a small output and directivity, it is difficult to adjust sensitivity of the communication in the information reading/writing device (reader/writer) side. Therefore, in the radio IC-mounted article of the present embodiment, since the first booster antenna is provided between the antenna connected to the IC chip and the second booster antenna, it is possible to perform a sensitivity adjustment easily. In addition, since the antenna connected to the IC chip, the first booster antenna, and the second booster antenna are provided separately, respectively, even if any one of the antennas fails, it is possible to replace this antenna easily.

In addition, the first booster antenna is provided separately from the substrate. That is, as described above, the second antenna 41 is provided in another body different from the inlet 30. Thus, even if the first booster antenna becomes larger, it may be disposed at a predetermined position without adding the physical load such as distortion and deflection to the substrate.

The first booster antenna has a portion bent in a direction different from the plane direction of the substrate. That is, as shown in FIG. 1, it is possible to more sensitively adjust the resonance of the second booster antenna by providing a portion that is bent in a direction different from one surface 33a of the substrate 33 of the inlet 30 on the radiating elements 43, 43 of the second antenna 41.

The second booster antenna may be a metal that article itself is made of That is, as described above, the columnar members may be made of metal, and it is preferable that the columnar member may be the second booster antenna. Since the columnar member functions as the second booster antenna, when information is communicated from the antenna connected to the IC chip, it is possible to perform more sensitively resonance compensation by providing the first booster antenna between the antenna connected to the IC chip and the second booster antenna.

For example, when an article includes a metallic frame, the first booster antenna is disposed with respect to the metal of the frame so that the first booster antenna and the metal of the frame are electromagnetically coupled, and the antenna connected to the IC chip is placed in the non-metallic part of the frame (a position in which the antenna and the metallic frame is not electromagnetically coupled, or the electromagnetically coupling is small). Thus, since the metallic frame acts as the second booster antenna, when the IC chip and the antenna for microwave band or ultrahigh frequency band are used, it is possible to adjust directivity and reading distance and to widen directivity without fine resonance setting.

The second booster antenna may be a metal attached to the article. That is, the second booster antenna may be a metal plate attached to the plastic container, or conductive fibers sewed in clothing.

As conductive fibers, for example, fibers (A) formed by spinning a composite by kneading conductive carbon or white-based metal oxide to a resin such as polyester resin, nylon or like, or fibers (B) formed by coating a thin film made of metal such as stainless steel, copper, titanium or like on various fibers by sputtering process.

As the fibers (A), fibers having the conductive layer made of a conductive carbon and a white metal oxide on the whole surface, fibers having an internal concealed conductive layer made of a conductive carbon and a white metal oxide (for example, the central portion along the longitudinal direction), or fibers having a conductive layer made of a conductive carbon and a white metal oxide, which is exposed partly on the surface may be used.

For example, when the second booster antenna is a metal plate attached to the plastic container, the first booster antenna is disposed with respect to the metal plate so that the first booster antenna and the metal plate are electromagnetically coupled, and the antenna connected to the IC chip is placed in non-metallic portion of the plastic container (portion in which the antenna and the metal plate is not electromagnetically coupled, or the electromagnetically coupling is small). Thus, since the metal plate acts as the second booster antenna, when the IC chip and the antenna for microwave band or ultrahigh frequency band are used, it is possible to adjust directivity and reading distance and to widen directivity without fine resonance setting.

Also, for example, when the second booster antenna is conductive fibers sewed in clothing, the first booster antenna is disposed with respect to the conductive fibers so that the first booster antenna and the conductive fibers are electromagnetically coupled, and the antenna connected to the IC chip is placed in non-conductive-fiber portion of the clothing (portion in which the antenna and the conductive fibers is not electromagnetically coupled, or the electromagnetically coupling is small). Thus, since the conductive fibers acts as the second booster antenna, when the IC chip and the antenna for microwave band or ultrahigh frequency band are used, it is possible to adjust directivity and reading distance and to widen directivity without fine resonance setting.

Next, as shown in FIGS. 1 to 5, a manufacturing method of the radio IC-mounted article of the present invention is described.

A second antenna 41 (the first booster antenna in the present invention) and a first antenna 32 (the antenna in the present invention) are provided to be coupled electromagnetically.

In addition, the second antenna 41 is disposed with respect to side edge portions 63B, 64B (columnar members, the metal of the article in the present invention) of a cage cart 60 so as to couple the second antenna 41 and the side edge portions 63B, 64B (columnar members) electromagnetically.

In addition, the first antenna 32 is disposed with respect to the side edge portions 63B, 64B (columnar member) of the cage cart 60 so that the first antenna 32 and the side edge portions 63B, 64B (columnar member) of the cage cart 60 are not coupled electromagnetically coupling.

As described above, the IC tag 10 having the radio IC-mounted article and the cage cart 60 is obtained.

Next, as shown in FIGS. 1 to 5, by describing a management method of the cage cart 60 using the IC tag 10 as an example, the management method of radio IC-mounted article of the present invention is described.

Firstly, on one surface 20a of a housing 20, an inlet 30 and the second antenna 41 are provided.

Then, as shown in FIGS. 4 and 5, the housing 20 is provided to bridge the side edge portions 63B, 64B of two adjacent peripheral wall portions 63, 64 of the cage cart 60. Outer fitting portions 21A, the 21B are fitted from outside to the side edge portions 63B, 64B. In the case, both ends of inlet 40 are held by being sandwiched between the outer fitting portions 21A, 21B of the housing 20 and the side edge portions 63B, 64B.

Then, a fixing member 50 is provided to bridge the side edge portions 63B, 64B of the two adjacent peripheral wall portions 63, 64 of the cage cart 60, so as to sandwich the inlet 30 and the second antenna 41 between the connecting portion 22 of the housing 20 and the connecting portion 53 of fixing member 50. The outer fitting portions 52A, 52B are fitted to the side edge portions 63B, 64B of the cage cart 60 from outside, respectively. The IC tag 10 is fixed to the side edge portions 63B, 64B of the cage cart 60.

In this state, reading/writing information for the IC chip 31 of the inlet 30 included in the IC tag 10 is performed in a non-contact state, and as a result, each cage cart 60 is managed separately.

The information written to the IC chip 31 may be an identification number of the cage cart 60, affiliation (storage location), administrator, types of articles carried by cage cart 60, manufacturer, manufacturing location, date of manufacture, ordering party, destination (address, phone number), storage location, or like.

In this way, according to the management method of the cage cart 60 using the IC tag 10, not only the cage cart 60 having the IC tag 10 may be accurately managed, but also work efficiency may be improved. In particular, according to the management method of this cage cart 60, even in the case that the cage cart 60 having almost equal appearance at a glance are placed so that many cage carts 60 are piled together and it is difficult to recognize each of them, each cage cart may be reliably identified and be managed separately.

When the side edge portions 63B, 64B are made of metal; and the antenna member 40 is disposed with respect to face the housing 20 so that some or all of the distal end portions of the radiating elements 43, 43 of the second antenna 41 are sandwiched between the side edge portions 63B, 64B made of metal and the outer fitting portions 21A, 21B; and further, the IC tag 10 is provided in a place of the cage cart 60 so that some or all of the distal end portion of the radiating elements 43, 43 of the second antenna 41 are provided to face and intersect the side edge portions 63B, to 64B, and as a result, electric current flows between the radiating elements 43, 43 and the side edge portions 63B, 64B by electromagnetic induction or electrostatic induction. Therefore, the side edge portions 63B, 64B may function as an extension portion of the second antenna 41. Thus, via the extension portion, by using an information reading/writing device (not shown), an information of the IC chip 31 of the inlet 30 is read/wrote in a non-contact state, and therefore it is possible to manage the cage cart 60 separately.

In this way, since the metal side edge portions 63B, 64B function as an extension of the second antenna 41, it is possible to widen directivity of the second antenna 41 by using the side edge portions 63B, 64B. Therefore, when only the second antenna 41 is used, and non-contact communication between the information reading/writing device and the IC tag 10 is performed from the longitudinal direction of the inlet 30, it is not possible to read or write information to IC chip 31 by the information reading/writing device. However, in the case of the present invention, from all directions, that is, 360° with respect to the IC tag 10, it is possible to read or write information to the IC chip by the information reading/writing device.

### (2) Second Embodiment

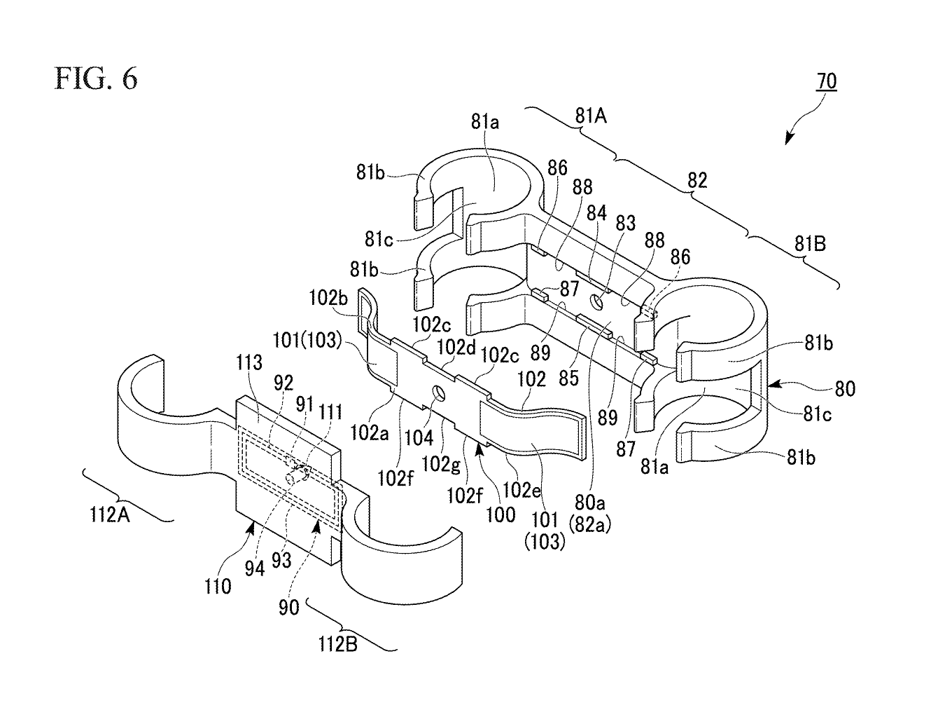

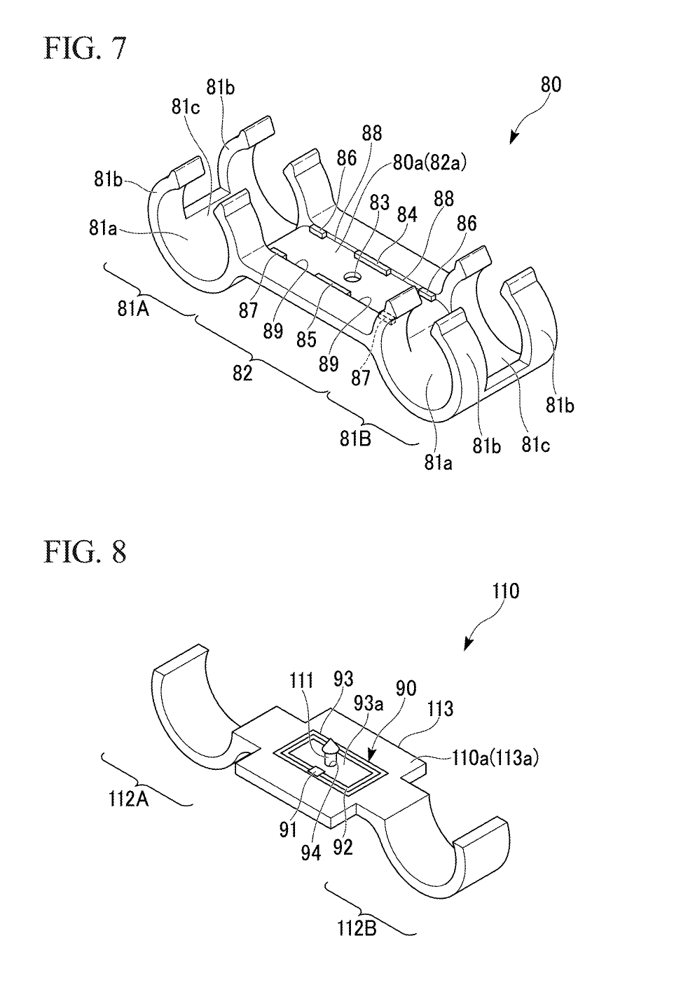

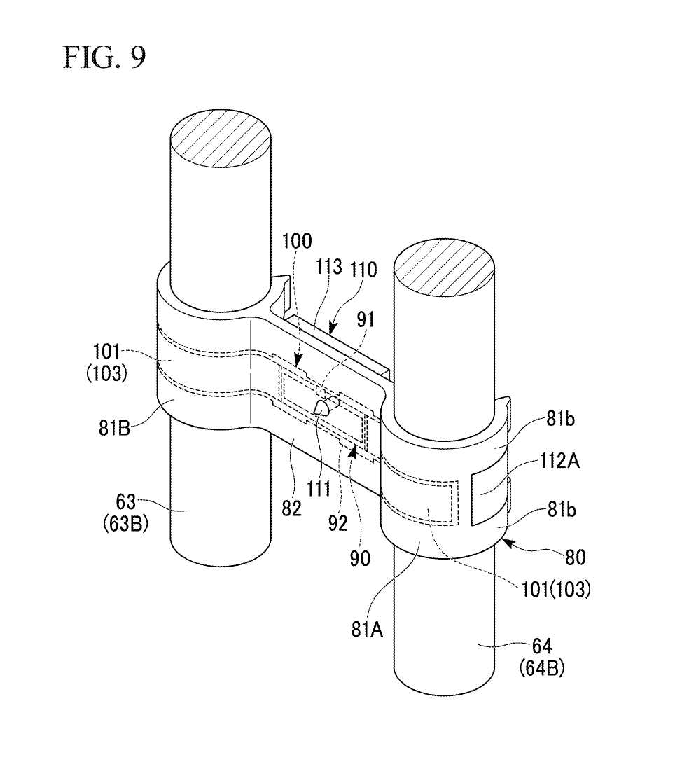

FIG. 6 is a schematic perspective view showing a second embodiment of the IC tag in the present invention. FIG. 7 is a schematic perspective view showing part of the second embodiment of the IC tag in the present invention. FIG. 8 is a schematic perspective view showing part of the second embodiment of the IC tag in the present invention. FIG. 9 is a schematic perspective view showing how to use the second embodiment of the IC tag in the present invention.

An IC tag 70 of the present embodiment includes a housing 80, an inlet 90, an antenna member 100 and a fixing member 110, wherein the inlet 90 is disposed on a surface 80a of the housing 80 and has an IC chip 91 and a first antenna 92; the first antenna 92 is the antenna in the present invention and is electrically connected to the IC chip 91; the antenna member 100 has a second antenna 101 which is the first booster antenna in the present invention and is arranged in the vicinity of the first antenna 92 in a non-bonding state with respect to the first antenna 92; and the fixing member 110 fixes the inlet 90 and the antenna member 100 to the housing 80.

The IC tag 70 is used, for example, by attaching it to the cage cart 60, as shown in FIG. 4. In the present embodiment, IC tag 70 is described when it is attached to the cage cart 60. The radio IC-mounted article of the present embodiment includes, for example, the IC tag 70, and the cage cart 60.

The inlet 90 includes a substrate 93, the IC chip 91, and the first antenna 92, wherein the substrate 93 is a film-like or sheet-like form and has a rectangular shape in planar view. In addition, the IC chip 91 and the first antenna 92 are provided on a surface 93a of the substrate 93. The IC chip 91 and the first antenna 92 are electrically connected to each other. In addition, the first antenna 92 is a loop antenna having a feeding point (portion for connecting with the IC chip 91).

Also, in the center of the substrate 93, a fitting hole 94 is provided for inserting a fitting projection 111 into the fitting hole 94, wherein the fitting projection 111 stands on a surface 110a of the later-described fixing member 110 (hereinafter, “one surface”), and the surface 110a faces the housing 80.

The antenna member 100 includes a substrate 102 and a second antenna 101, wherein the substrate 102 is a film-like or sheet-like form and has a substantially rectangular shape in planar view; and the second antenna 101 is composed of a pair of planar (rectangular) radiating elements 103,103, which are provided at an interval on a surface 102a of the substrate 102, to be opposed to each other, and face the first antenna 92 of inlet 90. Also, in the center of the substrate 102, the fitting hole 104 is provided for inserting the fitting projection 111 upright on one surface 110a of the later-described fixing member 110.

The second antenna 101 has a length corresponding to half wavelength of radio frequency of ultrahigh frequency band (UHF) or microwave band (300 MHz to 30 GHz) which is available in a non-contact IC module, such as a non-contact IC card. That is, the radiating elements 103,103 in the longitudinal direction have a length corresponding to ¼-wavelength. In addition, the radiating elements 103,103 provided on the surface 102a of the substrate 102 have a length that extend to outer fitting portions 81A, 81B of the housing 80 when the antenna member 100 is placed on the surface 82a of the connecting portion 82 of the housing 80, which will be described later.

In the vicinity of the first antenna 92, the means that the second antenna 101 is disposed in the non-bonding state with respect to the first antenna 92 is a state that the first antenna 92 and the second antenna 101 are not bonded (fixed) directly, however, these two antennas are electrically connected by electrostatic coupling or electromagnetic coupling.

Also, the first antenna 92 of inlet 90 is not an antenna for communicating with the information writing/reading device directly. The first antenna 92 of inlet 90 is an antenna for performing the electrical connection between the second antenna 101 of the antenna member 100 by electrostatic coupling or electromagnetic coupling. In other words, the second antenna 101 of the antenna member 100 communicates with the information writing/reading device directly.

In the portion of substrate 102 of the antenna member 100, which is placed on the surface 80a (the surface 82a of the connecting portion 82) on the housing 80, wherein the portion is a portion of the substrate 102 on which the radiating elements 103,103 are not provided in this embodiment and is a central portion of the substrate 102, a pair of rectangular ridges (fitting portions) 102c, 102c in planar view are provided across an interval, wherein the ridges 102c, 102c are provided so as to protrude from one side face 42b as a base, which is along the longitudinal direction of the substrate 102, and outward to the direction perpendicular to the longitudinal direction of the antenna member 100. As a result, between the pair of ridges (fitting portions) 102c, 102c, in other words, in the central portion in the longitudinal direction of the substrate 102, rectangular fitting recesses (fitting portions) 102d, 102d in planar view which are recessed inside and are perpendicular to longitudinal the direction of the antenna member 100 (longitudinal direction of the connecting portion 82 of the housing 80) are formed. The pair of ridges (fitting portions) 102c, 102c are provided at symmetrical positions with a center line perpendicular to the longitudinal direction of the connecting portion 82.

Similarly, in the portion of substrate 102 of the antenna member 100, which is placed on the surface 80a (the surface 82a of the connecting portion 82) on the housing 80, wherein the portion is a portion of the substrate 102 on which the radiating elements 103,103 are not provided in this embodiment and is a central portion of the substrate 102, a pair of rectangular ridges (fitting portions) 102f, 102f in planar view are provided across an interval, wherein the ridges 102f, 102f are provided so as to protrude from one surface 102e as a base, which is along the longitudinal direction of the substrate 102, and outward to the direction perpendicular to the longitudinal direction of the antenna member 100. As a result, between the pair of ridges (fitting portions) 102f, 102f, in other words, in the central portion in the longitudinal direction of the substrate 102, a rectangular in planar view fitting recesses (fitting portions) 102g, 102g which are recessed inside and are perpendicular to longitudinal the direction of the antenna member 100 (longitudinal direction of the connecting portion 82 of the housing 80) are formed. The pair of ridges (fitting portions) 102f, 102f are provided at symmetrical positions with a center line perpendicular to the longitudinal direction of the connecting portion 82.

The fitting recesses (fitting portions) 102d and 102g are provided at symmetrical positions with a center line parallel to the longitudinal direction of the connecting portion 82.

As a cage cart mounted with the IC tag 70, for example, the cage cart 60 is shown in FIG. 4.

When the IC tag 70, as shown in FIGS. 4 and 5, is attached to the cage cart 60, the housing 80 is arranged to bridge the two side edge portions 63B, 64B of two adjacent peripheral wall portions 63, 64 connected through a hinge member 66.

The housing 80 has a pair of outer fitting portions 81A, 81B and a tabular connecting portion 82, wherein the pair of outer fitting portions 81A, 81B are provided away from each other and fitted from the each outside to the two side edge portions 63B, 64B; and the connecting portion 82 is interposed between the pair of outer fitting portions 81A, 81B, so as to be perpendicular to the outer fitting portions 81A, 81B. In other words, the housing 80 has a substantially dumbbell shape which is formed by connecting the pair of outer fitting portions 81A, 81B through the connecting portion 82.

The outer fitting portions 81A, 81B include a pair of claw portions 81b, 81b and the connecting portion 81c, wherein the pair of claw portions 81b, 81b are provided apart from each other in the width direction of the housing 80; and the connecting portion 81c connecting the claw portions 81b, 81b are interposed between the pair of claw portions 81b, 81b. The width direction of the housing 80 is a direction along the longitudinal direction of the side edge portions 63B, 64B of the peripheral wall portion 63, 64 of the cage cart 60 wherein the side edge portions 63B, 64B are fitted from the outside by the outer fitting portions 81A, 81B of the housing 80, respectively. On the other hand, the longitudinal direction of the housing 80 is a direction perpendicular to the longitudinal direction of the side edge portions 63B, 64B of the peripheral wall portion 63, 64 of the cage cart 60 wherein the side edge portions 63B, 64B are fitted from the outside by the outer fitting portions 81A, 81B of the housing 80, respectively. In addition, surfaces (hereinafter, “inner face”) 81a, 81a of the outer fitting portions 81A, 81B wherein the surfaces face the side edge portions 63B, 64B, have shapes corresponding to external dimensions of the side edge portions 63B, 64B, which have an arc shape.

In addition, the inner surfaces 81a, 81a of the outer fitting portions 81A, 81B are the surface of the claw portion 81b wherein the surface faces the outer peripheral surface of the side edge portions 63B, 64B when the outer fitting portions 81A, 81B are fitted to the side edge portions 63B, 64B from the outside, and the surface of connecting portion 81c wherein the surface faces outer peripheral surface of the side edge portions 64B, 63B. The claw portions 81b, 81b are provided by along the external dimension (outer peripheral surface) of the side edge portions 63B, 64B, and have a longer length than that of the portion 81c and have a length in which ½ to ¾ of the external circumference of the side edge portions 64B, 63B is covered by the claw portions 81b, 81b.

As a result, when the outer fitting portions 81a, 81b are fitted to the side edge portions 63B, 64B from the outside, with respect to the outer peripheral surface of the side edge portions 63B, 64B, the bonding of the inner surfaces 81a, 81a of the outer fitting portions 81A, 81B increases. The IC tag 70 is firmly clamped to the side edge portions 63B, 64B.

In the central part of the surface 82a (hereinafter, “one surface”) of the connecting portion 82 of a housing 80, a circular fitting hole 83 in planar view penetrating through the connecting portion 82 in the thickness direction is provided, wherein the surface 82a faces the side edge portions 63B, 64B and the fitting hole 83 is fitted to a projection 111 standing in the center of one surface 110a of the fixing member 110.

Further, on the surface 82a of the connecting portion 82 of the housing 80, at the center of the connecting portion 82, a rectangular fitting projection (fitting portion) 84 in planar view extending in the longitudinal direction of the connecting portion 82 is provided, wherein the fitting projection 84 is fitted to a fitting recess 102d formed between protruding portions 102c, 102c provided on the substrate 102 of the antenna member 100.

Similarly, on the surface 82a of the connecting portion 82 of the housing 80, at the center of the connecting portion 82, a rectangular fitting projection (fitting portion) 85 in planar view extending in the longitudinal direction of the connecting portion 82 is provided, wherein the fitting projection 85 is fitted to a fitting recess 102g formed between protruding portions 102f, 102f provided on the substrate 102 of the antenna member 100. That is, the fitting projections 84 and 85 have almost the same shapes as the fitting recess 102d, 102g, and are provided at symmetrical positions with a center line parallel to the longitudinal direction of connecting portion 82.

Furthermore, on the surface 82a of the connecting portion 82 of the housing 80, at both ends in the longitudinal direction, four rectangular fitting projections in planar view (fitting portions) 86, 86, 87, 87 are protruded at a predetermined interval, wherein the fitting projections (fitting portions) 86, 86, 87, 87 are fitted to the projection portions 102c, 102c, 102f, 102f of the antenna member 100. In other words, the fitting projections 86 and 86 as a pair are fitted from the outside to one surface 102b of substrate 102 of the antenna member 100, and the fitting projections 87, 87 as a pair are fitted from the outside to the other side 102e of substrate 102 of the antenna member 100.

A recess 88, which is formed between the fitting projection 86 and the fitting projection 84, has almost the same shape as the external shape of the ridge portion 102c of the substrate 102 of the antenna member 100. Similarly, a recess 87 which is formed between the fitting projection 87 and the fitting projection 85 has almost the same shape as the external shape of the ridge 102f of the substrate 102 of the antenna member 100. Then, a pair of fitting projections 86, 86, and a pair of fitting projections 87, 87 are provided at symmetrical positions with a center line perpendicular to a longitudinal direction of the connecting portion 82.

The fixing member 110 schematically includes a pair of outer fitting portions 112A, 112B, and a planar connecting portion 113, four substantially rectangular columnar fitting projection 111, wherein the outer fitting portions 112A, 112B are fitted from the outside to the above-mentioned side edge portions 63B,64B, the connecting portion 113 is interposed between the pair of outer fitting portion 112A, 112B, and is perpendicular to the outer fitting portions 112A, 112B which are connected by the connecting portion 113; the columnar fitting projection 111 stands on the center of a surface 113a of the connecting portion 113 wherein the surface 113a faces the housing 80 (hereinafter, “one surface”). That, the fixing member 110 has a substantially dumbbell shape in which a pair of outer fitting portions 112A, 112B are connected via a connecting portion 113. The magnitude (area) of the connecting portion 113 is approximately equal to the portion 82 of the housing 80.

In addition, the external shape of outer fitting portions 112A, 112B of the fixing member 110 is equal to the gap between claw portions 81B, 81B which are provided in the outer fitting portions 81A, 81B of the housing 80. Therefore, when the fixing member 110 is fixed to the housing 80, the fitting projection 111 of the fixing member 110 is fitted into the fitting hole 83 of the housing 80. At the same time, the outer fitting portions 112A, 112B of fixing member 110 are fitted between the claw portions 81B, 81B of the outer fitting portions 81A, 81B of the housing 80. Therefore, the outer fitting portions 81A, 81B of the housing 80 and the outer fitting portions 112A, 112B of fixing member 110 are fitted to the above-mentioned side edge portions 63B, 64B from the outside. And as a result, the IC tag 70 is fixed to the cage cart 60.

The housing 80 and the fixing member 110 are configured in the same manner as the housing 20 and fixing member 50 of the first embodiment described above.

The substrate 93 of inlet 90 and the substrate 102 of the antenna member 100 are configured in the same manner as the substrate 33 of inlet 30 and the substrate 42 of the antenna member 40 of the first embodiment described above.

The IC chip 91 of the inlet 90 is configured in the same manner as the IC chip 31 of inlet 30 of the first embodiment described above.

The first antenna 92 of inlet 90 and the second antenna 101 of the antenna member 100 are configured in the same manner as the first antenna 32 of the inlet 30 and the second antenna 41 of the antenna member 40 of the first embodiment described above.

According to the IC tag 70, the fitting projections 84, 86, 86 provided in the connecting portion 82 of the housing 80 are fitted from the outside to one side 102b of substrate 102 of the antenna member 100; and the fitting projections 85, 87, 87 provided in the connecting portion 82 of the housing 80 are fitted from the outside to the other side 102e of substrate 102 of the antenna member 100; and further, in the state that the inlet 90 is provided on a surface 80a (in this case, above a surface 113a of connecting portion 113 of fixing member 110) of the housing 80, the housing 80 and the fixing member 110 are fitted to the side edge portions 63B 64B of the cage cart 60 from the outside. By that, the inlet 90 and the antenna member 100 are fixed to the surface 82a of the connecting portion 82 of the housing 80, therefore, during a work of installation of IC tag 70 to cage cart 60, the inlet 90 and antenna member 100 never fall off from housing 80. Therefore, it is possible to attach the IC tag 70 to the cage cart 60 easily. In addition, by using the outer fitting portions 81A, 81B of the housing 80 and the outer fitting portions 112A, 112B of fixing member 110, the IC tag 70 is fixed to the above-mentioned side edge portions 63B, 64B, therefore, it is possible to more firmly fix the IC tag 70 to the cage cart 60.

Also, since the inlet 90 and the antenna member 100 may be separated, when one of these is broken, it is possible to be used in the same manner by replacing only the broken member. Therefore, it is possible to reduce the cost.

Also, the IC tag 70 of this embodiment may be changed to various forms like the IC tag 10 of the first embodiment described above.

Also, the IC tag 70 of this embodiment is used similarly to the IC tag 10 of the first embodiment described above.

In addition, according to the radio IC-mounted article of the present embodiment, the same effect as the radio IC-mounted article of the first embodiment described above may be obtained.

In this embodiment, for example, the first antenna 92 is an antenna that is electrically connected to the IC chip in the radio IC-mounted article of the present embodiment, the second antenna 101 is the first booster antenna, and the side edge portions 63B, 64B (columnar members) of the peripheral wall portions 63, 64 of the cage cart 60 are the second booster antenna.

Also, the radio IC-mounted article of this embodiment may be modified into various forms as the same as the radio IC-mounted article of the first embodiment described above.

In addition, the radio IC-mounted article of the present embodiment may be produced in the same way as manufacturing method of the radio IC-mounted article of the first embodiment described above.

Also, the radio IC-mounted article of this embodiment is used as well as the radio IC-mounted article of the first embodiment described above.

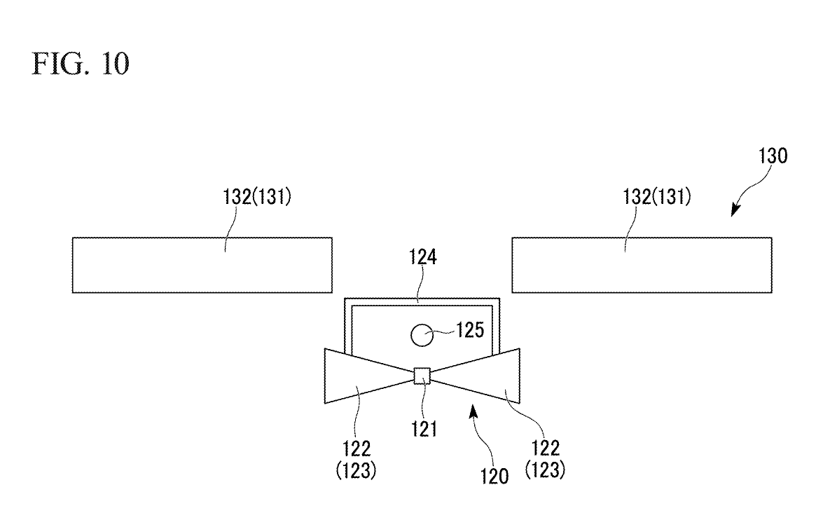

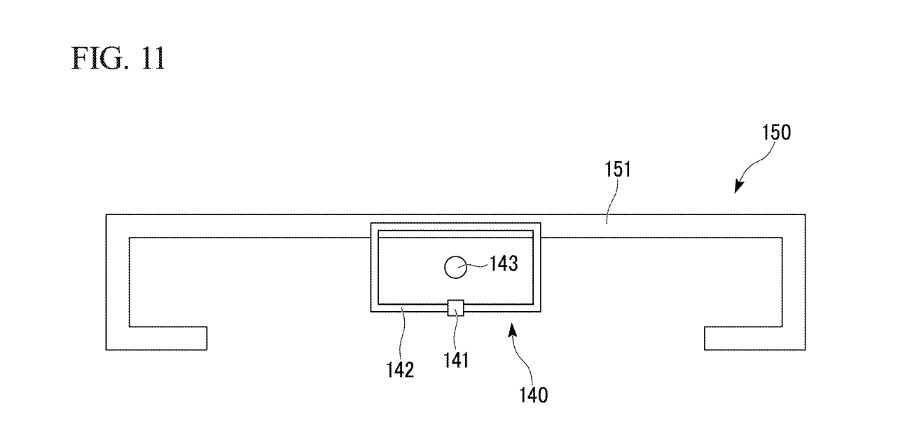

In addition, in the present embodiment, for example, the fitting hole 94 provided in the substrate 93 of the inlet 90 and the fitting hole 104 provided in substrate 102 of the antenna member 100 are inserted into by the fitting projection 111 which stands on one surface 110a of the fixing member 110. However, the invention is not limited thereto. In the present invention, for example, it is also possible to adopt such forms as shown in FIG. 10 or 11.

FIG. 10 is a schematic planar view showing an example of an arrangement of an inlet and an antenna member.

An inlet 120 includes an IC chip 121 and a first antenna 122. Also, the IC chip 121 and the first antenna 122 are electrically connected to each other. The first antenna 122 is a dipole antenna including a pair of radiating elements 123,123 opposed to each other and having feeding points on the opposite side (portion connected to the IC chip 121). The short-circuit section 124 for short-circuiting the radiating elements 123,123 are provided. Furthermore, in the area inside the short-circuit portion 124, a fitting hole 125 for inserting the fitting projection 111 provided upright on one surface 110a of the above fixing member 110 is provided.

On the other hand, the antenna member 130 includes a second antenna 131 including a pair of planar (rectangular) radiating elements 132,132 which are opposed to each other and are arranged at an interval and which face the first antenna 122 (radiating element 123,123) of the inlet 120.

The first antenna 122 of the inlet 120 and the second antenna 131 of the antenna member 130 are provided at a position keeping the electrical connection by electrostatic coupling or electromagnetic coupling without directly bonding (fixed).

FIG. 11 is a schematic planar view showing another example of an arrangement of an inlet and an antenna member.

An inlet 140 includes an IC chip 141 and a first antenna 142. The IC chip 141 and the first antenna 142 are electrically connected to each other. The first antenna 142 is a loop antenna having a feeding point (portion for connecting with the IC chip 141). Furthermore, in the area inside the first antenna 142, a fitting hole 143 for inserting the fitting projection 111 provided upright on one surface 110a of the above fixing member 110 is provided.

On the other hand, an antenna member 150 includes a second antenna 151 with U-shape in planar view.

The first antenna 142 of the inlet 140 and the second antenna 151 of the antenna member 150 are not bonded (fixed) directly, however, these two antennas are electrically connected by electrostatic coupling or electromagnetic coupling. Here, the two antennas are provided to overlap part of the second antenna 151 and a portion of the first antenna 142.

### (3) Third Embodiment

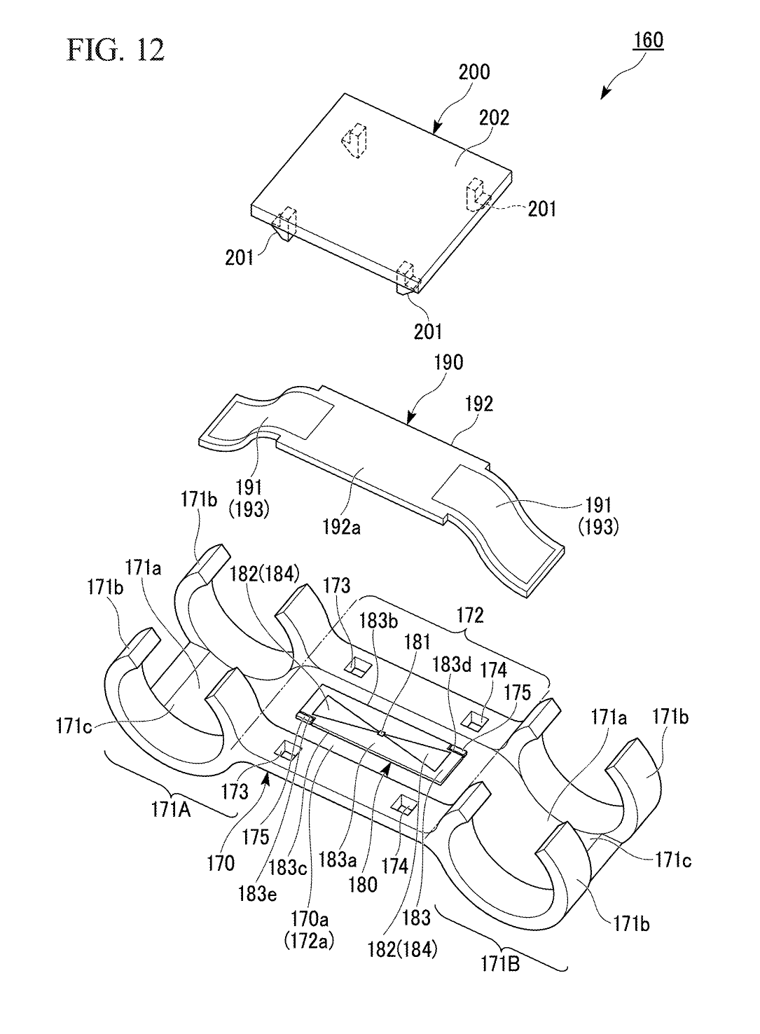

FIG. 12 is a schematic perspective view showing a third embodiment of the IC tag in the present invention.

An IC tag 160 of the present embodiment includes a housing 170, an inlet 180, an antenna member 190 and a fixing member 200, wherein the inlet 180 is disposed on a surface 170a of the housing 170 and has an IC chip 181 and the first antenna 182; the first antenna 182 is the antenna in the present invention and is electrically connected to the IC chip 181; the antenna member 190 has a second antenna 191 which is the first booster antenna in the present invention and is arranged in the vicinity of the first antenna 182 in a non-bonding state with respect to the first antenna 182; and the fixing member 200 fixes the inlet 180 and the antenna member 190 to the housing 170.

The IC tag 160 is used, for example, by attaching it to the cage cart 60, as shown in FIG. 4. In the present embodiment, IC tag 160 is described when it is attached to the cage cart 60. The radio IC-mounted article of the present embodiment includes, for example, the IC tag 160, and the cage cart 60.

The inlet 180 includes the substrate 183, the IC chip 181, and the first antenna 182, wherein the substrate 183 is a film-like or sheet-like form and has a rectangular shape in planar view. In addition, the IC chip 181 and the first antenna 182 are provided on a surface 183a of the substrate 183. The IC chip 181 and the first antenna 182 are electrically connected to each other. In addition, the first antenna 182 is a dipole antenna having a pair of radiating element 184,184 which are opposed to each other and each of which has a feeding point (portion for connecting with the IC chip 181) in the opposite side.

In the present embodiment, the inlet 180 is sized to fit within one surface 172a of the connecting portion 172 of the housing 170.

At one pair positions of a diagonal line of the substrate 183 of the inlet 180, rectangular fitting recesses 183d, 183e (fitting portions) in planar view are provided. The fitting recesses 183d, 183e recess inward in the direction perpendicular to longitudinal direction of inlet 180 (the longitudinal direction of the connecting portion 172 of the housing 170) from base ends which are the sides 183b, 183c along the longitudinal direction of the substrate 183. That is, the fitting recess 183d, 183e are provided at symmetrical positions with two center lines one of which is parallel to the longitudinal direction of the inlet 180 and another of which is perpendicular to the longitudinal direction of the inlet 180.

The antenna member 190 includes a substrate 192 and the second antenna 191, wherein the substrate 192 is a film-like or sheet-like form and has a substantially rectangular shape in planar view; and the second antenna 191 is composed of a pair of planar (rectangular) radiating elements 193,193, which are provided at an interval on a surface 192a of the substrate 192 to be opposed to each other, and overlap the first antenna 182 (radiating elements 193, 193) of inlet 180.

The second antenna 191 has a length corresponding to half wavelength of radio frequency of ultrahigh frequency band (UHF) or microwave band (300 MHz to 30 GHz) which is available in a non-contact IC module, such as a non-contact IC card. That is, the radiating elements 193,193 in the longitudinal direction have a length corresponding to ¼-wavelength. In addition, the radiating elements 193,193 provided on the surface 192a of the substrate 192 have a length that extend to outer fitting portions 171A, 171B of the housing 170 when the antenna member 190 is placed on the surface 172a of the connecting portion 172 of the housing 170.

In the vicinity of the first antenna 182, the means that the second antenna 191 is disposed in the non-bonding state with respect to the first antenna 182 is a state that the first antenna 182 and the second antenna 191 are not bonded (fixed) directly, however, these two antennas are electrically connected by electrostatic coupling or electromagnetic coupling.

The first antenna 182 of inlet 180 is not a member for directly communicating with the information writing/reading device, is a member for performing an electrical connection with the second antenna 191 of the antenna member 190 by electrostatic coupling or electromagnetic coupling. In other words, the second antenna 191 of the antenna member 190 directly communicates with the information writing/reading device.

As a cage cart mounted with IC tag 160, for example, a cage cart 60 is shown in FIG. 4.

When the IC tag 160, as shown in FIGS. 4 and 5, is attached to the cage cart 60, the housing 170 is arranged to bridge the two side edge portions 63B, 64B of two adjacent peripheral wall portions 63, 64 connected through a hinge member 66.

The housing 170 has a pair of outer fitting portions 171A, 171B and a tabular connecting portion 172, wherein the pair of outer fitting portions 171A, 171B are provided away from each other and fitted from the each outside to the two side edge portions 63B, 64B; and the connecting portion 172 is interposed between the pair of outer fitting portions 171A, 171B, so as to be perpendicular to the outer fitting portions 171A, 171B. In other words, the housing 170 has a substantially dumbbell shape which is formed by connecting the pair of outer fitting portions 171A, 171B through the connecting portion 172.

The outer fitting portions 171A, 171B include a pair of claw portions 171b, 171b and the connecting portion 171c, wherein the pair of claw portions 171b, 171b are provided apart from each other in the width direction of the housing 170; and the connecting portion 171c connecting the claw portions 171b, 171b are interposed between the pair of claw portions 171b, 171b. The width direction of the housing 170 is a direction along the longitudinal direction of the side edge portions 63B, 64B of the peripheral wall portion 63,64 of the cage cart 60 wherein the side edge portions 63B, 64B are fitted from the outside by the outer fitting portions 171A, 171B of the housing 170, respectively. On the other hand, the longitudinal direction of the housing 170 is a direction perpendicular to the longitudinal direction of the side edge portions 63B, 64B of the peripheral wall portion 63,64 of the cage cart 60 wherein the side edge portions 63B, 64B are fitted from the outside by the outer fitting portions 171A, 171B of the housing 170, respectively. In addition, surfaces (hereinafter, “inner face”) 171a, 171a of the outer fitting portions 171A, 171B wherein the surfaces face the side edge portions 63B, 64B, have shapes corresponding to external dimensions of the side edge portions 63B, 64B, which have an arc shape, for example.

In addition, the inner surfaces 171a, 171a of the outer fitting portions 171A, 171B are the surface of the claw portion 171b wherein the surface faces the outer peripheral surface of the side edge portions 63B, 64B when the outer fitting portions 171A, 171B are fitted to the side edge portions 63B, 64B from the outside, and the surface of connecting portion 171c wherein the surface faces outer peripheral surface of the side edge portions 64B, 63B. The claw portions 171b, 171b are provided by along the external dimension (outer peripheral surface) of the side edge portions 63B, 64B, and have a longer length than that of the portion 171c and have a length in which ½ to ¾ of the external circumference of the side edge portions 64B, 63B is covered by the claw portions 171b, 171b.

As a result, when the outer fitting portions 171a, 171b are fitted to the side edge portions 63B, 64B from the outside, with respect to the outer peripheral surface of the side edge portions 63B, 64B, the bonding of the inner surfaces 171a, 171a of the outer fitting portions 171A, 171B increases. The IC tag 160 is firmly clamped to the side edge portions 63B, 64B.

In both ends of the width direction of connecting portion 172 of the housing 170, on the side (one surface 172a) facing the edge portions 63B, 64B, rectangular fitting holes 173, 173, 174, 174 in planar view are provided at a predetermined interval, which are fitted to the fitting projections 201, 201, 201, 201 provided on the fixing member 200 and penetrate through the connecting portion 172 in the thickness direction. The fitting holes 173, 173, 174, 174 are provided at a position corresponding to the fitting projections 201, 201, 201, 201 of the fixing member 200. Furthermore, holes 173, 173 are one paired, and holes 174, 174 are paired.

Then, a pair of fitting holes 173, 173 and a pair of fitting holes 174,174 are provided at symmetrical positions with a center line perpendicular to the longitudinal direction of connecting portion 172.

In both ends of the connecting portion 172 of the housing 170, on a surface (one surface 172a) facing the above-mentioned columnar members (side edge portions 63B, 64B of cage cart 60), rectangular fitting projections (fitting portions) 175, 175 in planar view are provided to fit the recess 183d, 183e provided at the pair positions of diagonal line of the inlet 180 from the outside. That is, the fitting projections 175, 175 are provided at positions of diagonal line in the connecting portion 172.

The fitting projections 175, 175 have almost the same shape as the fitting recess 183d, 183e provided in the diagonal inlet 180. The fitting projections 175, 175 are provided at symmetrical positions with two center lines one of which is perpendicular to longitudinal direction the connecting portion 172 and another of which is parallel to the longitudinal direction.

A fixing member 200 includes a flat substrate 202 which have approximately equal magnitude of the housing 170 (area) and fitting projections 201, 201, 201, 201 having a shape of substantially quadrangular prism on four corners of a surface of the substrate 202 wherein the surface faces the connecting portion 172 of the housing 170.

The housing 170 and the fixing member 200 are configured in the same manner as the housing 20 and fixing member 50 of the first embodiment described above.

The substrate 183 of inlet 180 and the substrate 192 of the antenna member 190 are configured in the same manner as the substrate 33 of inlet 30 and the substrate 42 of the antenna member 40 of the first embodiment described above.

The IC chip 181 of the inlet 180 is configured in the same manner as the IC chip 31 of inlet 30 of the first embodiment described above.

The first antenna 182 of inlet 180 and the second antenna 191 of the antenna member 190 are configured in the same manner as the first antenna 32 of the inlet 30 and the second antenna 41 of the antenna member 40 of the first embodiment described above.

According to the IC tag 160, the fitting projections 175, 175 which are provided at both ends of the connecting portion 172 of the housing 170 are fitted to the fitting recess 183d,183e provided in diagonal of inlet 180; and the outer fitting portions 171A, 171B of the housing 170 are fitted to the side edge portions 63B, 64B of the cage cart 60 from outside; and further the projections 201, 201, 201, 201 provided at the four corners of fixing member 200 are fitted to the fitting hole 173, 173, 174, 174 of the connecting portion 172 of the housing 170. By that, the inlet 180 and the antenna member 190 are fixed to the surface 172a of the connecting portion 172 of the housing 170, and therefore, during a work of installation of IC tag 160 to cage cart 60, the inlet 180 and antenna member 190 never fall off from housing 170. Therefore, it is possible to attach the IC tag 160 to the cage cart 60 easily. In addition, the IC tag 160 is fixed to the cage cart 60 by sandwiching and holding the both ends of antenna member 190 between the side edge portions 63B,64B of the cage cart 60 and the outer fitting portions 171A, 171B of the housing 170.

Since the inlet 180 and antenna member 190 may be separated, when one of these is broken, it is possible to use the IC tag in the same manner by replacing only the broken member. Therefore, it is possible to reduce the cost.

The IC tag 160 of this embodiment may be changed to various forms like the IC tag 10 of the first embodiment described above.

Also, the IC tag 160 of this embodiment is used similarly to the IC tag 10 of the first embodiment described above.

In addition, according to the radio IC-mounted article of the present embodiment, the same effect as the radio IC-mounted article of the first embodiment described above may be obtained.

In this embodiment, for example, the first antenna 182 is electrically connected to the IC chip in the radio IC-mounted article of the present embodiment. The second antenna 191 is the first booster antenna. The side edge portions 63B, 64B of peripheral wall portions 63, 64 of the cage cart 60 (columnar members) the second booster antenna.

Also, the radio IC-mounted article of this embodiment may be modified into various forms as well as the radio IC-mounted article of the first embodiment described above.

In addition, the radio IC-mounted article of the present embodiment may be produced in the same way as manufacturing method of the radio IC-mounted article of the first embodiment described above.

Also, the radio IC-mounted article of this embodiment is used as well as the radio IC-mounted article of the first embodiment described above.

### (4) Fourth Embodiment

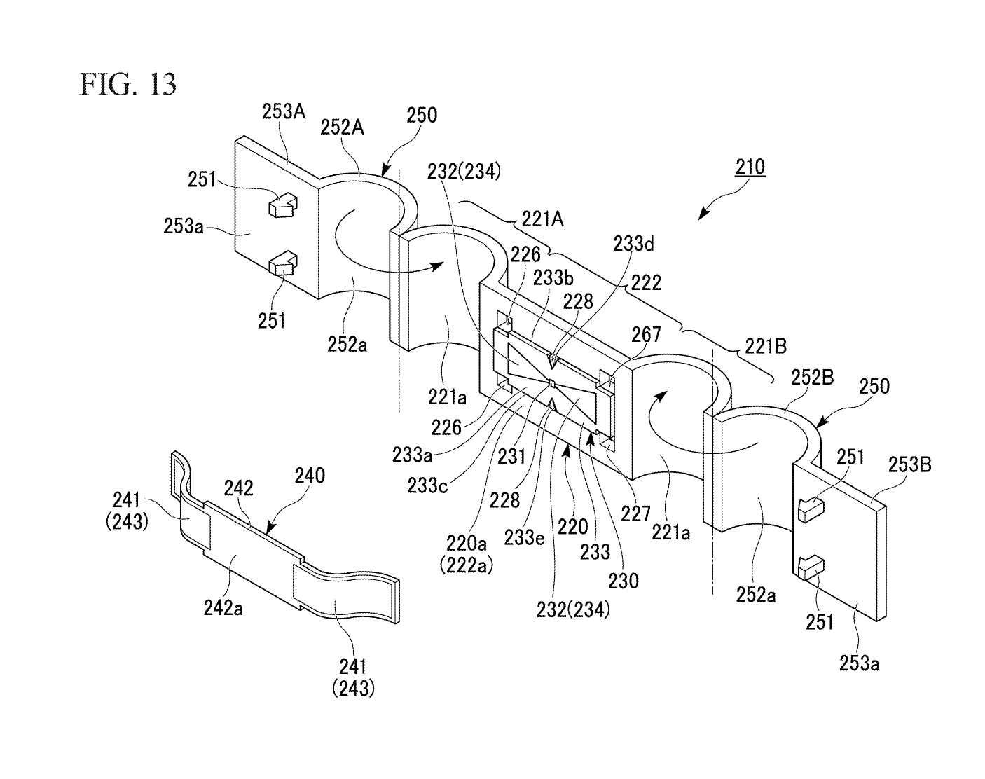

FIG. 13 is a schematic perspective view showing the fourth embodiment of the IC tag in the present invention.

An IC tag 210 of the present embodiment includes a housing 220, an inlet 230, an antenna member 240 and a fixing member 250, wherein the inlet 230 is disposed on a surface 220a of the housing 220 and has an IC chip 231 and a first antenna 232; the first antenna 232 is the antenna in the present invention and is electrically connected to the IC chip 231; the antenna member 240 has a second antenna 241 which is the first booster antenna in the present invention and is arranged in the vicinity of the first antenna 232 in a non-bonding state with respect to the first antenna 232; and the fixing member 250 is hinged to the housing 220 and fixes the inlet 230 and the antenna member 240 to the housing 220.

The IC tag 210 is used, for example, by attaching it to the cage cart 60, as shown in FIG. 4. In the present embodiment, IC tag 210 is described when it is attached to the cage cart 60. The radio IC-mounted article of the present embodiment includes, for example, the IC tag 210, and the cage cart 60.

The inlet 230 includes a substrate 233, an IC chip 231, and a first antenna 232, wherein the substrate 233 is a film-like or sheet-like form and has a rectangular shape in planar view. In addition, the IC chip 231 and the first antenna 232 are provided on a surface 233a of the substrate 233. The IC chip 231 and the first antenna 232 are electrically connected to each other. In addition, the first antenna 232 is a dipole antenna having a pair of radiating elements 234, 234 which are opposed to each other and each of which has a feeding point (portion for connecting with the IC chip 231) in the opposite side.

In the present embodiment, the inlet 230 is sized to fit within one surface 222a of the connecting portion 222 of the housing 220.

In the central portion of the longitudinal direction of the substrate 233 of the inlet 230, a pair of triangular fitting recesses (fitting portions) 233d, 233e in planar view are provided. The fitting recesses 233d, 233e recess inward in the direction perpendicular to longitudinal direction of inlet 230 (the longitudinal direction of the connecting portion 222 of the housing 220) from base ends which are the sides 233b, 233c along the longitudinal direction. That is, the fitting recess 233d, 233e are provided at symmetrical positions with a center lines parallel to the longitudinal direction of the inlet 230.

The antenna member 240 includes a substrate 242 and a second antenna 241, wherein the substrate 242 is a film-like or sheet-like form and has a substantially rectangular shape in planar view; and the second antenna 241 is composed of a pair of planar (rectangular) radiating elements 243,243, which are provided at an interval on a surface 242a of the substrate 242 to be opposed to each other, and overlap the first antenna 232 (radiating elements 243,243) of inlet 230.

The second antenna 241 has a length corresponding to half wavelength of radio frequency of ultrahigh frequency band (UHF) or microwave band (300 MHz to 30 GHz) which is available in a non-contact IC module, such as a non-contact IC card. That is, the radiating elements 243,243 in the longitudinal direction have a length corresponding to ¼-wavelength. In addition, the radiating elements 243, 243 provided on the surface 242a of the substrate 242 have a length that extend to outer fitting portions 221A, 221B of the housing 220 when the antenna member 240 is placed on the surface 222a of the connecting portion 222 of the housing 220.

In the vicinity of the first antenna 232, the means that the second antenna 241 is disposed in the non-bonding state with respect to the first antenna 232 is a state that the first antenna 232 and the second antenna 241 are not bonded (fixed) directly; however, these two antennas are electrically connected by electrostatic coupling or electromagnetic coupling.

The first antenna 232 of inlet 230 is not a member for directly communicating with the information writing/reading device, is a member for performing an electrical connection with the second antenna 241 of the antenna member 240 by electrostatic coupling or electromagnetic coupling. In other words, the second antenna 241 of the antenna member 240 directly communicates with the information writing/reading device.

As a cage cart mounted with IC tag 210, for example, a cage cart 60 is shown in FIG. 4.

When the IC tag 210, as shown in FIGS. 4 and 5, is attached to the cage cart 60, the housing 220 is arranged to bridge the two side edge portions 63B, 64B of two adjacent peripheral wall portions 63, 64 connected through a hinge member 66.

The housing 220 has a pair of outer fitting portions 221A, 221B and a tabular connecting portion 222, wherein the pair of outer fitting portions 221A, 221B are provided away from each other and fitted from the each outside to the two side edge portions 63B, 64B; and the connecting portion 222 is interposed between the pair of outer fitting portions 221A, 221B, so as to be perpendicular to the outer fitting portions 221A, 221B. In other words, the housing 220 has a substantially dumbbell shape which is formed by connecting the pair of outer fitting portions 221A, 221B through the connecting portion 222.

The shape of surfaces (hereinafter, “inner surfaces”) 221a, 221a of the outer fitting portions 221A, 221B wherein the surfaces 221a, 221a face the side edge portions 63B, 64B have the almost the same shapes as the outer shape of the side edge portions 63B, 64B, which have an arc shape, for example.

The inner surfaces 221a, 221a of the outer fitting portions 221A, 221B are the surfaces facing the outer peripheral surface of the side edge portions 63B, 64B when the outer fitting portions 221A, 221B are fitted to the side edge portions 63B, 64B from the outside.

In connecting portion 222 of the housing 220, on a surface (one surface 222a) facing the edge portions 63B, 64B, rectangular fitting holes 226, 226, 227, 227 in planar view are provided at a predetermined interval, at both ends in the longitudinal direction of the connecting portion 222 through the connecting portion 222 in the thickness direction. The holes 226, 226, 227, 227 are fitted to the fitting projections 251, 251, 251, 251 provided on fixing member 250. The Fitting holes 226, 226, 227, 227 are provided at positions corresponding to the fitting projections 251, 251, 251, 251 of the fixing member 250. Furthermore, the fitting holes 226, 226 are paired, and the fitting holes 227,227 are paired. Then, the pair of fitting holes 226, 226 and the pair of fitting holes 227,227 are provided at symmetrical positions with a center line perpendicular to a longitudinal direction of the connecting portion 222.

In addition, on a surface 222a (hereafter, “one surface”) of the connecting portion 222 of the housing 220 wherein the surface 222a faces the side edge portions 63B,64B of the cage cart 60, in a central portion of the connecting portion 222, a pair of triangular fitting projections (fitting portion) 228, 228 in planar view are provided in a predetermined distance. The fitting projections 228, 228 are perpendicular to the longitudinal direction of the connecting portion 222, and have apex angles facing each other. The fitting projections 228, 228 are fitting to the fitting recesses 233d, 233e provided on the substrate 233 of the inlet 230. The fitting projections 228, 228 have almost the same shape as the fitting recess 233d, 233e, and are provided at symmetrical positions with a center line parallel to the longitudinal direction of the connecting portion 222.

The fixing member 250 includes outer fitting portions 252A, 252B and holding sections 253A, 253B. The outer fitting portions 252A, 252B are hinged to ends of the outer fitting portions 221A, 221B of the housing 220 (the ends rather than the ends connecting with the connecting portion 222) and fitted to the side edge portions 63B, 64B from outside. The holding sections 253A, 253B extend in a side of the outer fitting portions 252A, 252B rather than the side in which the outer fitting portions 252A, 252B is hinged to the housing 220. The fixing member 250 is able to freely swing around the axis along the longitudinal direction of the side edge portions 63B, 64B by hinging the fixing member 250 and the outer fitting portions 221A, 221B of the housing 220 together.

The shape of surfaces (hereinafter, “inner surfaces”) 252a, 252a of the outer fitting portions 252A, 252B wherein the surfaces 252a, 252a face the side edge portions 63B, 64B have the almost the same shapes as the outer shape of the side edge portions 63B, 64B, which have an arc shape, for example.

The inner surfaces 252a, 252a of the outer fitting portions 252A, 252B are the surfaces facing the outer peripheral surface of the side edge portions 63B, 64B when the outer fitting portions 252A, 252B are fitted to the side edge portions 63B, 64B from the outside.

When the fixing member 250 swings around the axis along the longitudinal direction of the side edge portions 63B, 64B, the holding units 253A, 253B are disposed to face the connecting portion 222 of the housing 220. In that case, one end face of the holding portion 253A (the end face of the side that is not hinged with the outer fitting portion 221A of the housing 220) and one end face of the holding portion 253B (the end face of the side that is not hinged with the outer fitting portion 221B of the housing 220) contact each other in a center line perpendicular to the longitudinal direction of the connecting portion 222 of the housing 220, or, face each other at a distance with the center line. When the holding units 253A, 253B are disposed to face the connecting the portion 222 of the housing 220, a whole member formed by combining the two holding units 253A, 253B on the connecting portion 222 of the housing 220 has almost the same shape as the connecting portion 222 of the housing 220.

On surfaces 253a, 253a (hereinafter, “inner surface”) of the holding sections 253A, 253B wherein the surfaces 253a, 253a face the connecting portion 222 of the housing 220, the fitting projections 251, 251, 251, 251 are provided to be fitted to the fitting holes 226, 226, 227, 227 provided on the connecting portion 222 of the housing 220.

The housing 220 and the fixing member 250 are configured in the same manner as the housing 20 and the fixing member 50 of the first embodiment described above.

The substrate 233 of inlet 230 and the substrate 242 of the antenna member 240 are configured in the same manner as the substrate 42 of the antenna member 40 and the substrate 33 of inlet 30 of the first embodiment described above.

The IC chip 231 of inlet 230 is configured in the same manner as the IC chip 31 of the inlet 30 of the first embodiment described above.

The first antenna 232 of the inlet 230 and the second antenna 241 of the antenna member 240 are configured in the same manner as the first antenna 32 of inlet 30 and the second antenna 41 of the antenna member 40 of the first embodiment described above.

According to the IC tag 210, the fitting projections 228, 228 provided on the connecting portion 222 of the housing 220 are fitted to the fitting recess 233d, 233e of the inlet 230; and both of the outer fitting portions 221A, 221B of the housing 220 and the outer fitting portions 252A, 252B of the fixing member 250 are fitting to the edge portions 63B, 64B of the cage cart 60 from the outside; and further the fitting projections 251, 251, 251, 251 provided on the holding sections 253A, 253B of the fixing member 250 are fitted to the fitting holes 226, 226, 227, 227 provided in the connecting portion 222 of the housing 220. By that, the inlet 230 and the antenna member 240 are fixed to the surface 222a of the connecting portion 222 of the housing 220, and therefore, during a work of installation of IC tag 210 to cage cart 60, the inlet 230 and antenna member 240 never fall off from housing 220. Therefore, it is possible to attach the IC tag 210 to the cage cart 60 easily. In addition, by using the outer fitting portions 221A, 221B of the housing 220 and the outer fitting portions 252A, 252B of fixing member 250, the IC tag 210 is fixed to the side edge portions 63B, 64B, therefore, it is possible to more firmly fix the IC tag 210 to the cage cart 60.

Also, the IC tag 210 of this embodiment may be changed to various forms like the IC tag 10 of the first embodiment described above.

Also, the IC tag 210 of this embodiment is used similarly to the IC tag 10 of the first embodiment described above.

In addition, according to the radio IC-mounted article of the present embodiment, the same effect as the radio IC-mounted article of the first embodiment described above may be obtained.

In this embodiment, for example, the first antenna 232 is electrically connected to the IC chip in the radio IC-mounted article of the present embodiment. The second antenna 241 is the first booster antenna. The side edge portions 63B, 64B of peripheral wall portions 63, 64 of the cage cart 60 (columnar member) is the second booster antenna.

Also, the radio IC-mounted article of this embodiment may be modified into various forms as well as the radio IC-mounted article of the first embodiment described above.

In addition, the radio IC-mounted article of the present embodiment may be produced in the same way as manufacturing method of the radio IC-mounted article of the first embodiment described above.

Also, the radio IC-mounted article of this embodiment is used as well as the radio IC-mounted article of the first embodiment described above.

### (5) Fifth Embodiment

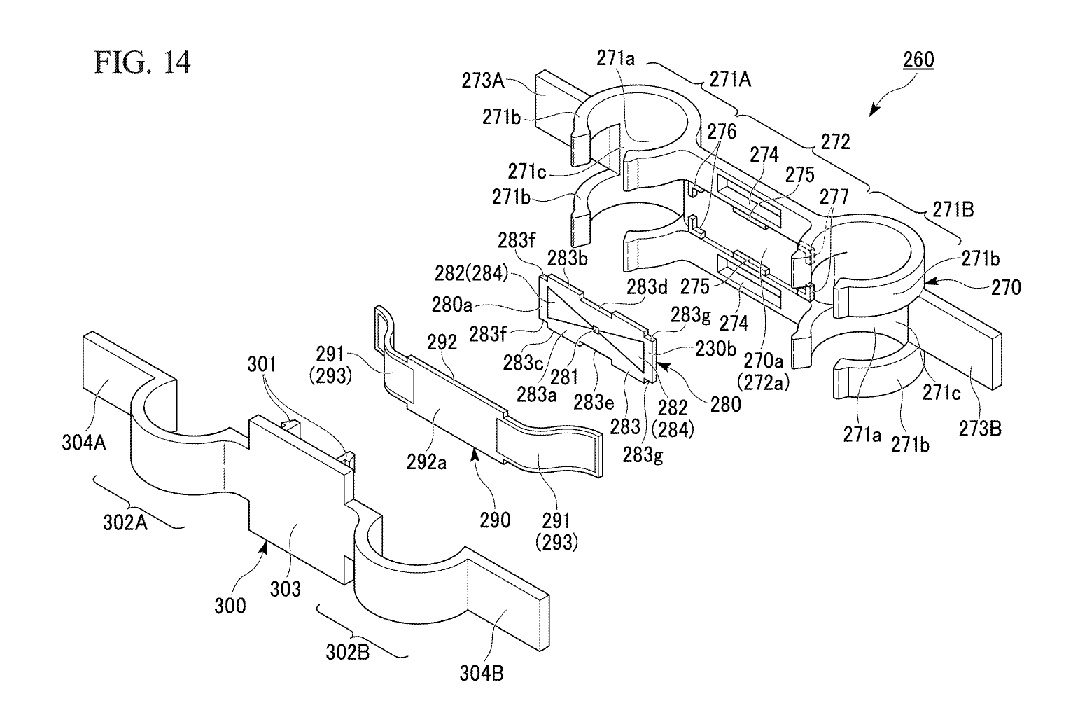

FIG. 14 is a schematic perspective view showing a fifth embodiment of the IC tag in the present invention.

An IC tag 260 of the present embodiment includes a housing 270, an inlet 280, an antenna member 290, and a fixing member 300. The inlet 280 is provided on one surface 270a of the housing 270 and includes an IC chip 281 and a first antenna 282 as the antenna of the present invention, which is electrically connected to the IC chip 281. The antenna member 290 includes a second antenna 291 which is the first booster antenna of the present invention provided in the vicinity of the first antenna 282 and in a non-bonding state with respect to the first antenna 282. The fixing member 300 is provided for fixing the inlet 280 and the antenna member 290 to the housing 270.

The IC tag 260 is used, for example, by attaching it to the cage cart 60, as shown in FIG. 4. In the present embodiment, the example that IC tag 260 is attached to the cage cart 60 is described. The radio IC-mounted article of the present embodiment, for example, includes the IC tag 260 and the cage cart 60.

The inlet 280 has a film-like or sheet-like substrate 283 having a rectangular shape in planar view, and includes the IC chip 281 and the first antenna 282. Also, the IC chip 281 and the first antenna 282 are provided on one surface 283a of the substrate 283, and electrically connected to each other. Also, the first antenna 282 is a dipole antenna having a pair of radiating elements 284,284 which are opposed to each other and each of which has a feeding point (portion for connecting with the IC chip 281) in opposite side.

In the present embodiment, the inlet 280 is sized to fit within one surface 272a of the connecting portion 272 of the housing 270.

In the center portion of longitudinal direction of the substrate 283 of the inlet 280, a pair of rectangular fitting recesses (fitting portions) 283d, 283e in planar view are formed by recessing inwardly in the direction perpendicular to the longitudinal direction of inlet 280 (longitudinal direction of the connecting portion 272 of the housing 270) from sides 283b 283c along the longitudinal direction as base ends. That is, the fitting recesses 283d, 283e are provided at symmetrical positions with a center line parallel to longitudinal direction of the inlet 280.

In addition, at four corners of the substrate 283 of the inlet 280, rectangular fitting recesses (fitting portions) 283f, 283f, 283g, 283g in planar view are provided. In other words, a pair of the fitting recesses 283f, 283f is provided at one end 280a of the inlet 280, and a pair of the fitting recesses 283g, 283g are provided at the other end 280b of the inlet 280. And, a pair of fitting recess 283f, 283f and a pair of fitting recesses 283g, 283g are provided at symmetrical positions with a center line perpendicular to the longitudinal direction of the connecting portion 272.

The antenna member 290 includes a substrate 292 and a second antenna 291, wherein the substrate 292 is a film-like or sheet-like form and has a substantially rectangular shape in planar view; and the second antenna 291 is composed of a pair of planar (rectangular) radiating elements 293, 293, which are provided at an interval on a surface 292a of the substrate 292 to be opposed to each other, and overlap the first antenna 282 of the inlet 280.

The second antenna 291 has a length corresponding to half wavelength of radio frequency of ultrahigh frequency band (UHF) or microwave band (300 MHz to 30 GHz) which is available in the non-contact IC module, such as the non-contact IC card. That is, the radiating elements 293,293 in the longitudinal direction have a length corresponding to ¼-wavelength. In addition, the radiating elements 293,293 provided on the surface 292a of the substrate 292 has a length that extend to the outer fitting portions 271A, 271B of the housing 270 when the antenna member 290 is placed on the surface 272a of the connecting portion 272 of the housing 270.

In the vicinity of the first antenna 282, the means that the second antenna 291 is disposed in the non-bonding state with respect to the first antenna 282 is a state that the first antenna 282 and the second antenna 291 are not bonded (fixed) directly. However, these two antennas are electrically connected by electrostatic coupling or electromagnetic coupling.

Also, the first antenna 282 of inlet 280 is not an antenna for communicating with the information writing/reading device directly. The first antenna 282 of inlet 280 is an antenna for performing the electrical connection between the second antenna 291 of the antenna member 290 by electrostatic coupling or electromagnetic coupling. In other words, the second antenna 291 of the antenna member 290 communicates with the information writing/reading device directly.

As a cage cart mounted with IC tag 260, for example, a cage cart 60 is shown in FIG. 4.

When the IC tag 260, as shown in FIGS. 4 and 5, is attached to the cage cart 60, the housing 270 is arranged to bridge the two side edge portions 63B, 64B of two adjacent peripheral wall portions 63, 64 connected through a hinge member 66.

The housing 270 includes a pair of outer fitting portions 271A, 271B and a flat connecting portion 272. The outer fitting portions 271A, 271B are provided away from each other, and are fitted to the side edge portions 63B, 64B from the outside. The flat connecting portion 272 is provided between the pair of outer fitting portions 271A, 271B and connected the outer fitting portions 271A, 271B in the manner that connecting portion 272 is perpendicular to the outer fitting portions 271A, 271B. That, the housing 270 is a substantially dumbbell shape formed by connecting a pair of outer fitting portions 271A, 271B via a connecting portion 272.

The outer fitting portions 271A, 271B includes a pair of claw portions 271b, 271b disposed apart from each other in the width direction of the housing 270, and a connecting portion 271c which is provided between pair of claw portions 271b, 271b and connect the claw portions 271b, 271b. The width direction of the housing 270 is a direction along the longitudinal direction of side edge portions 63B, 64B of the peripheral wall portions 63,64 of the cage cart 60, wherein the outer fitting portions 271A, 271B of the housing 270 are fitted to the edge portions 63B,64B from the outside. On the other hand, the longitudinal direction of the housing 270 is a direction perpendicular to the longitudinal direction of side edge portions 63B, 64B of the peripheral wall portions 63,64 of the cage cart 60, wherein the outer fitting portions 271A, 271B of the housing 270 are fitted to the edge portions 63B,64B from the outside. Also, the surfaces 271a, 271a of the outer fitting portions 271A, 271B wherein the surfaces face the edge portions 63B, 64B (hereinafter, “Inner surfaces”) have almost the same shape as an outer shape of the side edge portions 63B, 64B.

In the outer fitting portions 271A, 271B, extending portions 273A, 273B are provided. The extending portions 273A, 273B are formed by extending outside the connecting portion 271c which connects the claw portions 271b, 271b. The extending portions 273A, 273B have a shape of a flat plate and are parallel to the longitudinal direction of the connecting portion 272 of the housing 270.

On a surface of the connecting portion 272 of the housing 270 wherein the surface face the side edge portions 63B, 64B (one surface 272a), at both ends of the width direction, rectangular holes 274, 274 in planar view are provided to penetrate through the connecting portion 272 in the thickness direction. The rectangular holes 274, 274 are fitted to the four fitting projections 301 provided on the fixing member 300. Also, the fitting holes 274,274 are provided at symmetrical positions with a center line parallel to the longitudinal direction of the connecting portion 272.

Furthermore, on one surface 272a of the connecting portion 272 of the housing 270, in the central portion of the connecting portion 272, a pair of rectangular fitting projections (fitting portions) 275, 275 in planar view are provided at a predetermined interval, wherein the fitting projections (fitting portions) 275, 275 extend in the longitudinal direction of the connecting portion 272 and are fitted to the fitting recesses 283e, 283d provided in the substrate 283 of the inlet 280.

In other words, the fitting projections 275,275 have the almost same shape as the fitting recesses 283d, 283e and are provided at symmetrical positions with a center line parallel to the longitudinal direction of the connecting portion 272.

Further, on one surface 272a of the connecting portion 272 of the housing 270, at both ends in the longitudinal direction, four L-shaped fitting projections (fitting portions) 276, 276, 277, 277 in planar view are protruded at a predetermined interval, wherein the fitting projections 276, 276, 277, 277 are fitted to the fitting recesses 283f, 283f, 283g, 283g from the outside which are provided on the four corners of the inlet 280. That is, the fitting projection 276,276 are paired to be fitted from the outside to one end 280a of the inlet 280, and the fitting projections 277,277 are paired to be fitted from the outside to another end 280b of the inlet 280.

The shape of the fitting projections 276, 276, 277, 277 is almost the same as the outer shape of the fitting recesses 283f, 283f, 283g, 283g provided at the four corners of inlet 280.

Then, the pair of fitting projections 276,276, and the pair of fitting projections 277,277 are provided at symmetrical positions with a center line perpendicular to a longitudinal direction of the connecting portion 272.

The fixing member 300 schematically includes a pair of outer fitting portions 302A, 302B, and a planar connecting portion 303, and four substantially rectangular columnar fitting projections 301, wherein the outer fitting portions 302A, 302B are fitted from the outside to the above-mentioned side edge portions 63B,64B, the connecting portion 303 is interposed between the pair of outer fitting portions 302A, 302B, and is perpendicular to the outer fitting portions 302A, 302B which are connected by the connecting portion 303; the columnar fitting projection 301 stands on the four corners of a surface of the connecting portion 303 wherein the surface faces the housing 270. That is, the fixing member 300 has a substantially dumbbell shape in which a pair of the outer fitting portions 302A, 302B are connected via the connecting portion 303. The magnitude (area) of the connecting portion 303 is approximately equal to the connecting portion 272 of the housing 270. Furthermore, the four fitting projections 301 are provided at symmetrical positions with one center line perpendicular to the longitudinal direction of the connecting portion 303, or with another center line parallel to the longitudinal direction of the connecting portion 303.

In addition, the external shape of outer fitting portions 302A, 302B of the fixing member 300 is equal to the gap between claw portions 271b, 271b which are provided in the outer fitting portions 271A, 271B of the housing 270. Therefore, when the fixing member 300 is fixed to the housing 270, the fitting projections 301, 301, 301, 301 of the fixing member 300 are fitted into the fitting holes 274, 274 of the housing 270. At the same time, the outer fitting portions 302A, 302B of fixing member 300 are fitted between the claw portions 271b, 271b of the outer fitting portions 271A, 271B of the housing 270. Therefore, the outer fitting portions 271A, 271B of the housing 270 and the outer fitting portions 302A, 302B of fixing member 300 are fitted to the side edge portions 63B, 64B from the outside. And as a result, the IC tag 10 is fixed to the cage cart 60.

Also, in the outer fitting portions 302A, 302B, extending portions 304A, 304B which extend outwardly are provided. The extending portions 304A, 304B have a flat-plate shape of, and are parallel to the longitudinal direction of the connecting portion 303 of the fixing member 300.

The housing 270 and the fixing member 300 are configured in the same manner as the housing 20 and the fixing member 50 of the first embodiment described above.

The substrate 283 of the inlet 280, the substrate 292 of the antenna member 290 are configured in the same manner as the substrate 33 of the inlet 30 and the substrate 42 of the antenna member 40 of the first embodiment described above.

The IC chip 281 of inlet 280 is configured in the same manner as the IC chip 31 of the inlet 30 of the first embodiment described above.

The second antenna 291 of the antenna member 290 and first antenna 282 of inlet 280 are configured in the same manner as the second antenna 41 of the antenna member 40 and the first antenna 32 of inlet 30 of the first embodiment described above.

According to this IC tag 260, the fitting projections 275,275 provided in the connecting portion 272 of the housing 270 are fitted to the fitting recesses 283d, 283e of the inlet 280; and the fitting projections 276, 276, 277, 277 provided on the connecting portion 272 of the housing 270 are fitted to one end 280a and another end 280b of the inlet 280; and then the fitting projections 301, 301, 301, 301 provided on the connecting portion 303 of fixing member 300 are fitted to the fitting holes 274,274 provided in the connecting portion 272 of the housing 270; and further the housing 270 and fixing member 300 are fitted to the side edge portions 63B,64B of the cage cart 60 described above from the outside. And as a result, the inlet 280 and the antenna member 290 are fixed on one surface 272a of the connecting portion 272 of the housing 270, and therefore, during a work of installation of the IC tag 260 to the cage cart 60, the inlet 280 and the antenna member 290 never fall off from the housing 270. Therefore, it is possible to attach the IC tag 260 to the cage cart 60 easily. In addition, by using the outer fitting portions 271A, 271B of the housing 270 and the outer fitting portions 302A, 302B of the fixing member 300, the IC tag 260 is fixed to the side edge portions 63B, 64B; therefore, it is possible to more firmly fix the IC tag 260 to the cage cart 60.

The IC tag 260 of this embodiment may be changed to various forms like the IC tag 10 of the first embodiment described above.

Also, the IC tag 260 of this embodiment may be used similarly to the IC tag 10 of the first embodiment described above.

In addition, according to the radio IC-mounted article of the present embodiment, the same effect as the radio IC-mounted article of the first embodiment described above may be obtained.

In this embodiment, for example, the first antenna 282 is electrically connected to the IC chip in the radio IC-mounted article of the present embodiment. The second antenna 291 is the first booster antenna. The side edge portions 63B, 64B of peripheral wall portions 63, 64 of the cage cart 60 (columnar member) is the second booster antenna.

Also, radio IC-mounted article of this embodiment may be modified into various forms as well as the radio IC-mounted article of the first embodiment described above.

In addition, the radio IC-mounted article of the present embodiment may be produced in the same way as manufacturing method of the radio IC-mounted article of the first embodiment described above.

Also, the radio IC-mounted article of this embodiment is used as well as the radio IC-mounted article of the first embodiment described above.

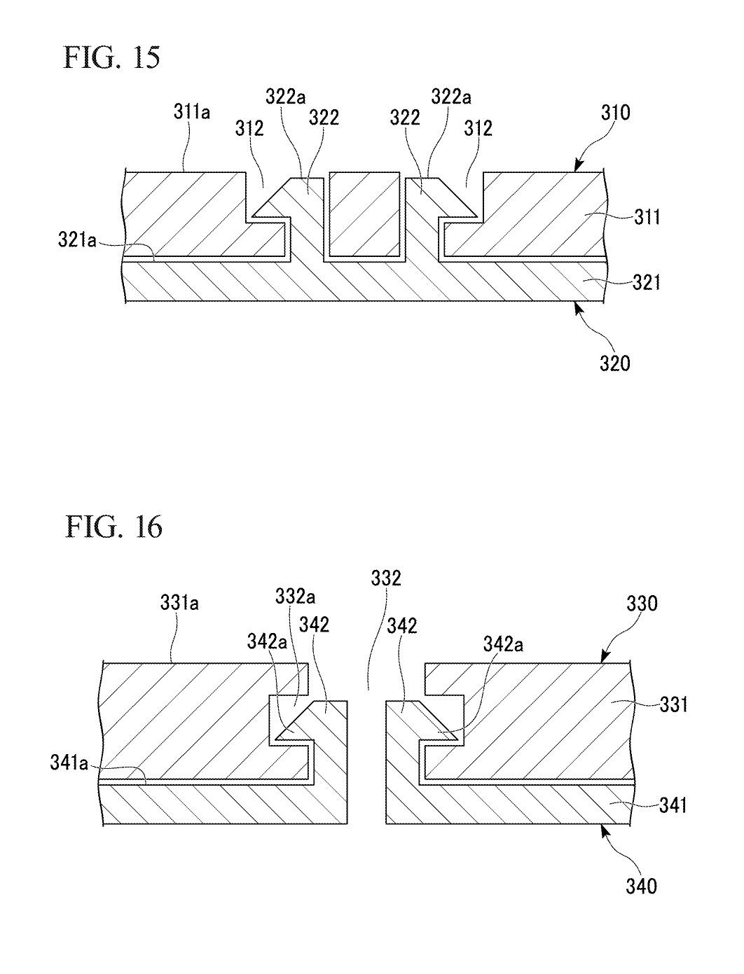

From the first to fifth embodiments described above, for example, the fitting projections provided on the connecting portion of the fixing member are fitted to the fitting holes provided in the connecting portion of the housing. The tips of the fitting projections protrude from a surface of the housing wherein the surface is the opposite surface with respect to the surface facing the fixing member. The invention is not limited thereto. In the present invention, for example, it is also possible to adopt such forms as shown in FIGS. 15 to 18.

FIG. 15 is a schematic cross-sectional view showing an example of a fitting structure of a housing and a fixing member. This cross-sectional view, for example, in FIG. 5, is a cross-sectional view taken along the thickness direction of the connecting portion of the housing and the connecting portion of the fixing member

As shown in FIG. 15, in a connecting portion 311 of a housing 310, fitting holes 312, 312 which penetrate through the connecting portion 311 in the thickness direction are provided. The fitting projections 322 and 322 are fitted to the fitting holes 312, 312 on a surface 321a (hereinafter, “one surface”) of the connecting portion 321 of the fixing member 320 wherein the surface 321a faces housing 310.

In this example, since the thickness of the housing 310 is larger than the height of the fitting projection 322 (length from the surface 321a of the connecting portion 321 of fixing member 320 to an upper surface 322a of the fitting projection 322), even the fitting projections 322 and 322 are fitted to the holes 312, 312, the fitting projections 322 and 322 do not protrude from a surface 311a of the connecting portion 311 of the housing 310 wherein the surface 311a is an opposite face with respect to the surface facing the fixing member 320.

As described above from the first to the fifth embodiments, when the fitting projections provided on connecting portion of the fixing member are fitted to the fitting holes provided in the connecting portion of the housing, the tip of the fitting projection of the fixing member protrudes from the housing's opposite surface with respect to the surface facing the fixing member. Since it is easy to pull out the tip of the fitting projections, by grasping the fitting projections, it is possible to easily remove the fitting projections of the connecting portion of the fixing member from the fitting holes in the connecting portion of the housing. On the other hand, as shown in FIG. 15, the fitting projections 322, 322 do not protrude from the surface 311a of the connecting portion 311 of the housing 310 wherein the surface 311a is an opposite face with respect to the surface facing the fixing member 320. In this case, it is difficult to catch the tips of the fitting projections 322, 322. Therefore, it become difficult to remove the fitting projections 322, 322 of the connecting portion 321 of the fixing member 320 from the fitting holes 312 and 312 of the connecting portion 311 of the housing 310 by grasping the fitting projections 322, 322.

As described above, for example, the fitting projections 322, 322 which stand on the connecting portion 321 of the fixing member 320 are fitted to the fitting holes 312, 312 which are provided in the connecting portion 311 of the housing 310. However, the invention is not limited thereto. In the present invention, the fitting projections which stand on a surface of a connecting portion of a housing wherein the surface faces the fixing member may be provided to be fitted to fitting holes which are provided to penetrate through a connecting portion of the fixing member in the thickness direction.

FIG. 16 is a schematic sectional view showing another example of the fitting structure of the housing and fixing member. This cross-sectional view, for example, in FIG. 5, is a cross-sectional view taken along the thickness direction of the connecting portion of the fixing member and the connecting portion of the housing.

As shown in FIG. 16, in a connecting portion 331 of a housing 330, fitting holes 332, 332 are provided which penetrate through the connecting portion 331 in the thickness direction. Fitting projections 342 and 342 are fitted to the fitting holes 332, 332 on a surface 341a (hereinafter, “one surface”) of the connecting portion 341 of the fixing member 340 wherein the surface 341a faces the housing 330. In the interior of the fitting hole 332 of the housing 330, a recess 332a which recesses in a direction perpendicular to the thickness direction of the connecting portion 331 of the housing 330 is provided. A locking portion 342a which is provided at the distal end of the fitting projections 342 and 342 is locked to the recess 332a. As a result, the fixing member 340 is fixed to the housing 330.

In this example, since the locking portions 342a, 342a provided at the distal end of the fitting projections 342, 342 of the fixing member 340 are locked to the recess 332a provided inside the fitting hole 332 of the housing 330, even the fitting projections 342 and 342 are fitted to the holes 332, 332, the fitting projections 342 and 342 do not protrude from a surface 331a of the connecting portion 331 of the housing 330 wherein the surface 331a is an opposite face with respect to the surface facing the fixing member 340.

As described above from the first to the fifth embodiments, when the fitting projections provided on connecting portion of the fixing member are fitted to the fitting holes provided in the connecting portion of the housing, the tip of the fitting projection of the fixing member protrudes from the housing's opposite surface with respect to the surface facing the fixing member. Since it is easy to pull out the tip of the fitting projection, by grasping the fitting projection, it is possible to easily remove fitting projections of connecting portion of the fixing member from the fitting hole in the connecting portion of the housing. On the other hand, as shown in FIG. 16, the fitting projections 342 and 342 does not protrude from the surface 331a of connecting portion 331 of the housing 330 wherein the surface is opposite surface with respect to the surface facing the fixing member 340. In this case, it is difficult to knob the tips of the fitting projections 342 and 342. Therefore, it become difficult to remove the fitting projections 342, 342 of the connecting portion 341 of the fixing member 340 from the fitting holes 332 and 332 of the connecting portion 331 of the housing 330 by grasping the fitting projections 342 and 342.

Here, the fitting hole 332 is provided in the connecting portion 331 of the housing 330, and for example, the fitting projections 342, 342 standing on the connecting portion 341 of fixing member 340 may be fitted to this hole 332. However, the present invention is not limited thereto. In the present invention, a fitting hole may be provided to penetrate through the connecting portion in the thickness direction in the connecting portion of the fixing member, and the fitting projections standing on a surface of the connecting portion of the housing wherein the surface faces the fixing member may be fitted to the fitting hole.

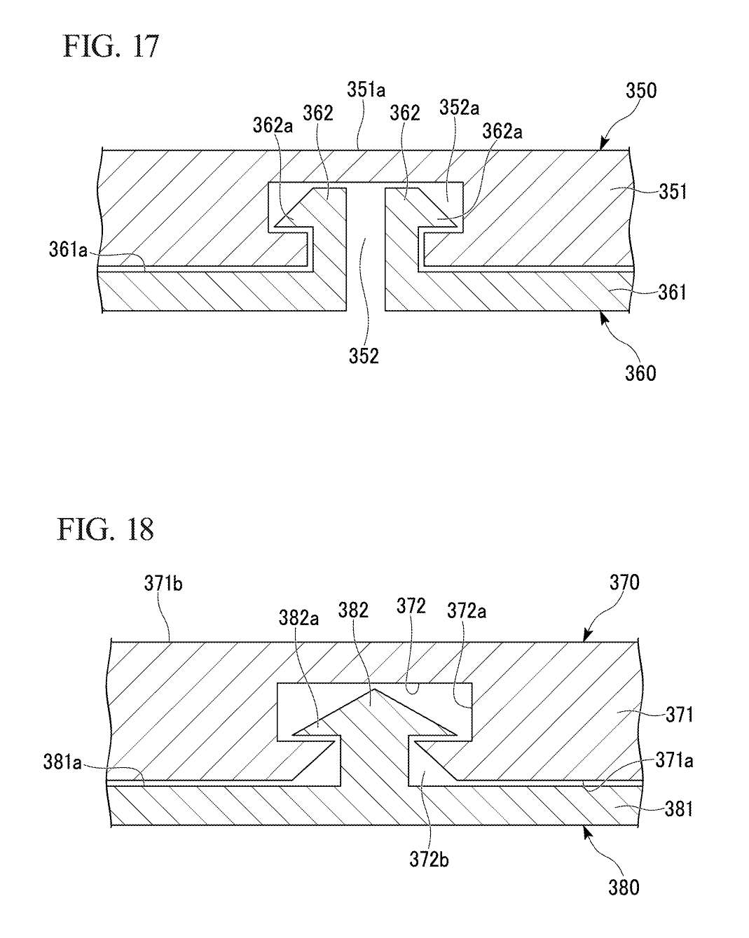

FIG. 17 is a schematic sectional view showing another example of the fitting structure of the housing and fixing member. This cross-sectional view, for example, in FIG. 5, is a cross-sectional view taken along the thickness direction of the connecting portion of the fixing member and the connecting portion of the housing.

As shown in FIG. 17, in a connecting portion 351 of a housing 350, fitting recess 352 which recesses in the thickness direction of the connecting portion 351 is provided. The fitting projections 362, 362 are fitted in the fitting recess 352 on a surface 361a (hereinafter, “one surface”) of the connecting portion 361 of the fixing member 360 wherein the surface 361a faces the housing 350. In the interior of the fitting recess 352 of the housing 350, a recess 352a which recesses in a direction perpendicular to the thickness direction of the connecting portion 351 of the housing 350 is provided. A locking portion 362a which is provided at the distal end of the fitting projections 362 and 362 is locked to the recess 352a. As a result, the fixing member 360 is fixed to the housing 350.

In this example, since the locking portion 362a provided at the distal end of the fitting projections 362, 362 of the fixing member 360 is locked to the recess 352a provided inside the fitting recess 352 of the housing 350, even the fitting projections 362 and 362 are fitted to the recess 352, 352, the fitting projections 362 and 362 does not protrude from a surface 351a of the connecting portion 351 of the housing 350 wherein the surface 351a is an opposite face with respect to the surface facing the fixing member 360.

As described above from the first to the fifth embodiments, when the fitting projections provided on connecting portion of the fixing member are fitted to the fitting holes provided in the connecting portion of the housing, the tip of the fitting projection of the fixing member protrudes from the housing's opposite surface with respect to the surface facing the fixing member. Since it is easy to pull out the tip of the fitting projection, by grasping the fitting projection, it is possible to easily remove fitting projections of connecting portion of the fixing member from the fitting hole in the connecting portion of the housing. On the other hand, as shown in FIG. 17, the fitting projections 362 and 362 do not protrude from a surface 351a of connecting portion 351 of the housing 350 wherein the surface is opposite face with respect to the surface facing the fixing member 360. In this case, it is difficult to catch the tips of the fitting projections 362 and 362. Therefore, it become difficult to remove the fitting projections 362, 362 of the connecting portion 361 of the fixing member 360 from the fitting recess 352 of the connecting portion 351 of the housing 350 by grasping the fitting projections 362, 362.

Here, the fitting recess 352 is provided in the connecting portion 351 of the housing 350, and for example, the fitting projections 362, 362 standing on the connecting portion 361 of fixing member 360 may be fitted to the recess 352. However, the present invention is not limited thereto. In the present invention, a fitting recess may be provided in the connecting portion of the fixing member, and the fitting projections standing on a surface of the connecting portion of the housing wherein the surface faces the fixing member may be fitted to the fitting hole.

FIG. 18 is a schematic sectional view showing another example of a fitting structure of a housing and a fixing member. This cross-sectional view, for example, in FIG. 5, is a cross-sectional view taken along the thickness direction of the connecting portion of the fixing member and the connecting portion of the housing.

As shown in FIG. 18, in the connecting portion 371 of the housing 370, fitting recess 372 is provided which recesses in the thickness direction of the connecting portion 371. The fitting projections 382 is fitted in the fitting recess 372 on a surface 381a (hereinafter, “one surface”) of the connecting portion 381 of the fixing member 380 wherein the surface 381a faces housing 370. In the interior of the fitting recess 372 of the housing 370, the recess 372a which recesses in a direction perpendicular to the thickness direction of the connecting portion 371 of the housing 370 is provided. A locking portion 382a which is provided at the distal end of the fitting projection 382 is locked to the recess 352a. As a result, the fixing member 380 is fixed to the housing 370. Moreover, an opening 372b of the fitting recess 372 of the housing 370 from a surface 371a facing the fixing member 380 is provided in connecting portion 371 of the housing 370. The opening 372b has a tapered shape which width becomes narrower towards the inside of the fitting recess 372. Therefore, when the fitting projection 382 of the fixing member 380 is pushed into the fitting recess 372 of the housing 370, the opening 372b of the fitting recess 372 is deflected inwardly to fit the fitting projection 382 into the fitting recess 372 easily. However, after the fitting projection 382 is fitted into the fitting recess 372, it is difficult to pull out the projection 382 from the fitting recess 372.

In this example, since the locking portion 382a provided at the distal end of the fitting projection 382 of the fixing member 380 is locked to the recess 372a provided inside the fitting recess 372 of the housing 370, even the fitting projection 382 is fitted to the recess 372, the fitting projection 382 does not protrude from a surface 371a of the connecting portion 371 of the housing 370 wherein the surface 371a is an opposite face with respect to the surface facing the fixing member 380.

As described above from the first to the fifth embodiments, when the fitting projections provided on connecting portion of the fixing member are fitted to the fitting holes provided in the connecting portion of the housing, the tip of the fitting projection of the fixing member protrudes from the housing's opposite surface with respect to the surface facing the fixing member. Since it is easy to pull out the tip of the fitting projection, by grasping the fitting projection, it is possible to easily remove fitting projections of connecting portion of the fixing member from the fitting hole in the connecting portion of the housing. On the other hand, as shown in FIG. 18, the fitting projection 382 does not protrude from the surface 371a of the connecting portion 371 of the housing 370 wherein the surface 371a is opposite face with respect to the surface facing the fixing member 380. In this case, it is difficult to catch the tip of the fitting projection 382. Therefore, it become difficult to remove the fitting projection 382 of the connecting portion 381 of the fixing member 380 from the fitting recess 372 of the connecting portion 371 of the housing 370 by grasping the fitting projection 382.

Here, the fitting recess 372 is provided in the connecting portion 371 of the housing 370, and for example, the fitting projection 382 standing on the connecting portion 381 of fixing member 380 may be fitted to the recess 372. However, the present invention is not limited thereto. In the present invention, a fitting recess may be provided in a connecting portion of a fixing member, and fitting projections standing on a surface of a connecting portion of a housing wherein the surface faces the fixing member may be fitted to the fitting hole.

### REFERENCE NUMBERS IN DRAWINGS

10, 70, 160, 210, 260 . . . IC tag
20, 80, 170, 220, 270 . . . housing
21A, 21B, 52A, 52B, 81A, 81B, 112A, 112B, 171A, 171B, 221A, 221B, 252A, 252B, 271A, 271B, 302A, 302B . . . outer fitting portion
22, 53, 82, 113, 172, 222, 272, 303 . . . connecting portion
30, 90, 180, 230, 280 . . . inlet
31, 91, 181, 231, 281 . . . IC chip
32, 92, 182, 232, 282 . . . first antenna
33, 42, 93, 102, 183, 192, 233, 242, 283, 292 . . . substrate
34, 43, 103, 184, 193, 234, 243, 284, 293 . . . radiating element
40, 100, 190, 240, 290 . . . antenna member
41, 101, 191, 241, 292 . . . second antenna
50, 110, 200, 250, 300 . . . fixing member
60 . . . cage cart
61 . . . mounting table
62, 63, 64 . . . peripheral wall portion
63B, 63C, 64B . . . side edge portion
65 . . . wheels
66, 67 . . . hinge member
68 . . . support
69 . . . stopper

1. A radio IC-mounted article, which operates in microwave band or ultrahigh frequency band, comprising
a substrate on which an IC chip and an antenna electrically connected to the IC chip are mounted,
a first booster antenna electromagnetically coupled to the antenna,
a second booster antenna electromagnetically coupled to the first booster antenna, and
an article on which the substrate, the first booster antenna and the second booster antenna are mounted.

2. The radio IC-mounted article of claim 1, wherein the first booster antenna is provided separately from the substrate.

3. The radio IC-mounted article of claim 1, wherein the first booster antenna comprises a portion which is bent in a direction different from the surface direction of the substrate.

4. The radio IC-mounted article of claim 1, wherein the second booster antenna is a metal which the article is originally made of.

5. The radio IC-mounted article of claim 1, wherein the second booster antenna is a metal which is attached to the article.

6. The radio IC-mounted article of claim 1, wherein
the article comprises at least one columnar member, and
the radio IC-mounted article comprises
a housing which is attached to the article, one portion of which is provided to face and intersect the columnar member;
the substrate having the antenna and the IC chip, which is disposed on one surface of the housing;
the first booster antenna which is disposed in a vicinity of the antenna in a non-bonding state with respect to the antenna; and
a fixing member disposed to face the housing, for fixing the first booster antenna and the substrate to the housing so that at least a distal portion of the antenna is provided to face and intersect the columnar member.

7. A radio IC-mounted article, comprising
a substrate on which an IC chip which operates in microwave band or ultrahigh frequency band and an antenna electrically connected to the IC chip are mounted;
a first booster antenna electromagnetically coupled to the antenna;
a second booster antenna electromagnetically coupled to the first booster antenna; and
an article having a metal,
wherein the first booster antenna and the antenna are disposed so that the first booster antenna is electromagnetically coupled to the antenna;
the first booster antenna and the metal of the article are disposed so that the first booster antenna is electromagnetically coupled to the metal of the article; and
the antenna and the metal of the article are disposed so that the antenna is not electromagnetically coupled to the metal of the article.

8. A method manufacturing a radio IC-mounted article which comprises
a substrate on which an IC chip which operates in microwave band or ultrahigh frequency band and an antenna electrically connected to the IC chip are mounted;
a first booster antenna electromagnetically coupled to the antenna;
a second booster antenna electromagnetically coupled to the first booster antenna; and
an article having a metal,
wherein the method comprises steps of
disposing the first booster antenna and the antenna so that the first booster antenna is electromagnetically coupled to the antenna;
disposing the first booster antenna and the metal of the article so that the first booster antenna is electromagnetically coupled to the metal of the article; and
disposing the antenna and the metal of the article so that the antenna is not electromagnetically coupled to the metal of the article.

9. A management method for a radio IC-mounted article which comprises
a substrate on which an IC chip which operates in microwave band or ultrahigh frequency band and an antenna electrically connected to the IC chip are mounted;
a first booster antenna electromagnetically coupled to the antenna;
a second booster antenna electromagnetically coupled to the first booster antenna at least one columnar member;
an article on which the substrate, the first booster antenna, the second booster antenna are mounted, and at least one columnar member;
a housing which is attached to the article, one portion of which is provided to face and intersect the columnar member; and
a fixing member disposed to face the housing,
wherein the management method comprises steps of
disposing the substrate having the IC chip and the antenna on one surface of the housing;
disposing the first booster antenna in the vicinity of the antenna in a non-bonding state with respect to the antenna;
disposing fixing member to face the housing, for fixing the first booster antenna and the substrate to the housing so that at least a distal portion of the antenna is provided to face and intersect the columnar member; and
carrying out reading/writing information to the IC chip in a non-contact manner by using an information reading/writing device.
